(19) United States
(12) Patent Application Publication
(10) Pub. No.: US 2007/0269788 A1
(43) Pub. Date: Nov. 22, 2007

(54) E learning platform for preparation for standardized achievement tests

(76) Inventors: James Flowers, Las Vegas, NV (US); Jason C. Sparks, Denver, CO (US); Viswanath Parameswaran, Singapore (SG)

Correspondence Address: RYAN KROMHOLZ & MANION, S.C., POST OFFICE BOX 26618, MILWAUKEE, WI, 53226, US

(21) Appl. No.: 11/800,376

(22) Filed: May 4, 2007

Related U.S. Application Data
(60) Provisional application No. 60/797,757, filed on May 4, 2006.

(51) Int. Cl. G09B 3/00

(52) U.S. Cl. 434/350

(57) ABSTRACT

A database driven system for preparing for a standardized test. The database includes an analysis of previous tests, a Question Pool, and study resources. Based on the analysis of previous tests, the system pulls questions from the Question Pool to create diagnostic tests. The diagnostic tests are administered to the user. Based on the results of the diagnostic tests and the student's goals, the system develops an individualized Study Plan for the student. The Study Plan can be based on an analysis of previous tests, the student's performance on the diagnostic test, the student's goals, or any combination thereof. The Study Plan identifies the areas that are of most importance for the student to learn. The student may they use the study resources based on the results of the Study Plan. The system uses a variety of tools to make the study process more efficient and motivate the student.

### RELATED APPLICATIONS

This application claims the benefit of co-pending provisional Application Ser. No. 60/797,757 filed on 4 May 2006, and entitled “E Learning Platform for Preparation for Standardized Achievement Tests.”

### BACKGROUND OF THE INVENTION

There are a number of standardized multiple choice exams which have been categorized as “high stakes” exams because they are used as part of a process to approve or deny admission to schools or jobs. Examples of these are the MCAT (Medical College Admissions Test) and the LSAT (Law School Admission Test) among many others. A number of commercial and private entities have created a number of preparation courses for these tests. The preparation programs are divided roughly into those that are classroom or live based, those that are paper/books based, and those that have some type of computer or on-line component.

The formal literature comparing commercial or other programs in terms of how well they prepare students for standardized exams is wanting. For the MCAT, the AAMC (American Association of Medical Colleges) states that commercial review courses are not necessary, and they provide only marginal benefit. Yet, tens of thousands of students use the commercial programs to prepare for the MCAT on a yearly basis. In fact, reviews estimate that 95% of all medical school applicants do some type of formal preparation.

The MCAT is a standardized test administered by the AAMC (American Association of Medical Colleges) and required for admission by nearly 100% of all medical schools in the United States. The MCAT is designed to help the admissions committee determine who is best suited for medical school. Thus, it is important for students to do well on this test.

The MCAT is divided into four subtests: Physical Sciences, Biological Sciences, Verbal Reasoning, and a Writing Sample. The Biological Sciences portion of the MCAT includes Biology and Organic Chemistry. The Physical Sciences portion of the MCAT includes Physics and General Chemistry. Math is included but is integrated into the science sections, mostly the Physical Sciences. The Verbal Reasoning portion of the MCAT includes passages from Humanities, Social Sciences, and Natural Sciences.

As stated above, there are many commercial programs available to prepare for the MCAT. However, a number of problems have been identified by students. Many test preparation programs identify a large volume of material to study, but do not provide direction for study. It is therefore desirable to provide a system by which students are directed towards what to study and in what order.

Also, studying for a test such as the MCAT is very time consuming. It is therefore desirable to provide a system that optimizes the student's study time to get the most benefit from the amount of time studied. Different students have different responsibilities such as class schedules, family responsibilities, and jobs. Many test preparation programs have prescheduled meeting times. Therefore, it is desirable to provide a system which allows a student to determine their own study schedule and study at their own pace.

Many test preparation programs have a standard predetermined study program. However, students have different backgrounds, and therefore have different strengths and weaknesses. For this reason it is desirable to provide a system that is dynamic and adjustable to each student. For this reason it is also desirable to utilize a diagnostic test to identify each individual student's strength and weaknesses.

One of the biggest complaints of students is that they study very hard for the test but do poorly on it. This is due to improper learning for the test. It is therefore desirable that a test-preparation system provides for optimal learning of the material to allow for optimal use of it during test-time.

Finally, students and advisors are concerned that students are motivated by and engaged by the test-preparation program. It is therefore desirable to provide a test-preparation system that includes components that motivate and engage students for optimal preparation.

### SUMMARY OF THE INVENTION

The present invention provides a system for preparing a user for a standardized test. The system includes means for providing assessment tools, means for providing study materials, and means for providing support tools.

The assessment tools may include a diagnostic test. The system may include a question pool with a plurality of questions. The diagnostic test may be generated by the system by drawing questions from the question pool. The assessment tools may further include previously administered test provided by the testing entity.

The system may further include online user access to any or all portions of the system. The system may further include means for analyzing and storing the results of the diagnostic test. The system may further provide means for viewing the results of at least one diagnostic test. The study materials may include presentations on at least one specific content area covered by the standardized test. The study materials may further include presentations on at least one specific test taking skill. The study materials may further include an explanation of the answers of at least one previously administered standardized test. The study materials may further include a glossary. The study materials may further include at least one flashcard. The study materials may further include at least one equation. The study materials may further include a flag tool. The study materials may further include a comment tool. The study materials may further include at least one audio recording. The study materials may further include at least one video recording. The study materials may further include at least one ancillary reading material.

The system may further include means for processing an analysis of at least one previously administered test.

The system may further include means for generating a study plan based on the results of at least one diagnostic test and the analysis of at least one previously administered test.

The system may further include means for entering user information into the system. The user information may include user's goal score on the standardized test.

The system may further include means for generating a study plan based on the results of at least one diagnostic test, the analysis of at least one previously administered test, and the user's goal score.

The system may further include means for sending at least a portion of the study materials to a portable receiving device.

The invention also provides a computerized method for improving a user's performance on a standardized test. The method includes the steps of administering a diagnostic test to the user, analyzing the results of the diagnostic test, generating a study plan, providing study materials to the user, and repeating the process until the user is prepared to take the standardized test.

The method may also include providing the user with support resources.

The method may further include step of accepting user data. The user data may include a goal test score.

The method may further include the step of analyzing at least one previously administered test.

The study plan may be generated based on at least the results of the diagnostic test. The study plan is generated based on at least the user goal test score. The study plan may be generated on at least the results of analysis of the previously administered test.

The invention provides a method of providing standardized test preparation services. The method includes compiling a question pool, compiling at least one study materials, preparing an analysis of at least one previously administered test, storing said question pool, said at least one study materials, and said analysis of at least one previously administered test electronically, generating at least one diagnostic test, said diagnostic test being generated from said question pool based on the analysis of said at least one previously administered test, administering said at least one diagnostic test to a user, storing the results of said at least one diagnostic test electronically, and providing access to said study materials to at least one user.

The method may further include storing user profile data. The user profile data may include a goal test score.

The method may further include generating a study plan, wherein said study plan is based on the results of said at least one diagnostic test, the analysis of said at least one previously administered test and the user goal test score.

The method may further include displaying the study plan in the order in which the user should review the at least one study material.

The method may further include providing user support resources electronically. The support resources may include receiving at least one user question, providing an answer to said question, storing said answer to said user question electronically, and providing access to said answer to said user question to said at least one user.

Additional objects and advantages of the invention will be set forth in the following description, or may be learned through practice of the invention.

### BRIEF DESCRIPTION OF THE DRAWINGS

FIG. 1A is a chart depicting the resources that populate the database of the present invention.

FIG. 1B is a chart depicting the system.

FIG. 2 is a chart depicting the overall structure of the system of the present invention.

FIG. 3 is a chart depicting the structure of an alternate embodiment of the Test Center of FIG. 2.

FIG. 4 is a continuation of the chart of FIG. 3.

FIG. 5 is a continuation of the chart of FIG. 3.

FIG. 6 is a continuation of the chart of FIG. 3.

FIG. 7 is a continuation of the chart of FIG. 3.

FIG. 8 is a continuation of the chart of FIG. 3.

FIG. 9 is a continuation of the chart of FIG. 3.

FIG. 10 is a continuation of the chart of FIG. 3.

FIG. 11 is a chart depicting the structure of a menu bar of the present invention.

FIG. 12 is a chart depicting the method of a preferred embodiment of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

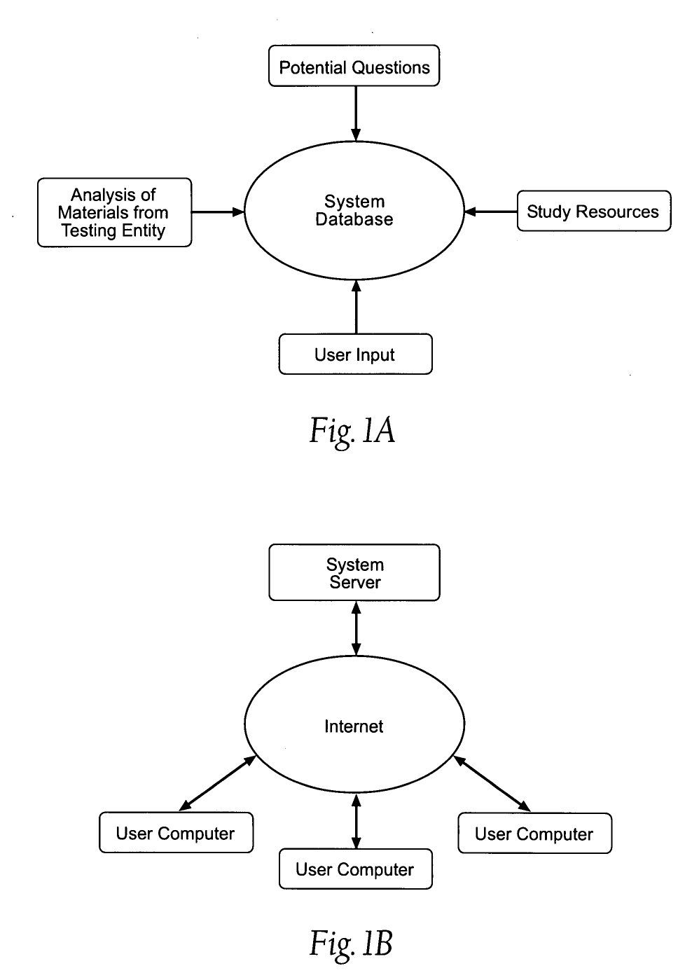

The present invention is comprehensive, individualized database driven on-line system for the preparation of a student for an achievement type standardized test maximizing the efficient use of time and providing motivation of which monitoring of progress and usable feedback are key components. FIG. 1A shows the resources that populate the system database. First, a relational database of specific test content and specific test skills is created for a standardized test using actual examples of full or partial length tests or using the closest available simulation of the test. Initial assessment of the student is performed in the test specific content requirements of the subject matter. The initial assessment may also include assessments of non-content factors which impact successful test preparation. Next, an actual test or the closest simulation possible is used to evaluate skills and content application required by the actual standardized test. The system then takes the results of this testing and develops an individualized study program for the student to maximize their scaled score on the standardized exam by only studying test specific content and skills that they need the most. The non-content analysis will result in recommendations to the student to correct deficiencies and problems identified. Students and their instructors, advisors or interested persons can monitor progress.

The system is designed to maximize the efficient use of the time available for study by having the test taking, test assessment, content, resources (such as flashcards or equation discussion and audio and video options) and test specific study skills, fully integrated, interactional, immediately available and limitable by what the student needs most to maximize their score. Time efficiency also comes from the navigational structure created by the system and the profiling which repeatedly determines only what is essential for the student to continue to study. Monitoring and feedback results from the creation of a special interactive interface for the student, a Support Center, with instructor virtual classroom options, and the diagnostic testing reports. Comprehensive individualized preparation results from the in-depth review, provision of multiple alternative learning mechanisms and integration of the content, skills and diagnostic components of the system.

The system assumes the standard use of computers (whether desktop, lap top or otherwise portable or mobile such as cellular phones or equivalents), monitors/interfaces, operating systems (such as Windows or Linux or others), internet capability with wire based or wireless connections, software such as produced by Microsoft and other providers, remote server with adequate storage capacity/processing capacity/security capacity, text messaging, email and portable sending and receiving devices, and commercial systems for on-line live interactive conferencing such as Glance, Breeze, and others. Also, the standard demographic and other information a student/user would prepare and enter in order to use an internet or interactional program is assumed as standard including the necessity of passwords, fees, etc.

As shown in FIG. 1B, the system is preferably stored on a server connected to the internet. The student users are also connected to the internet. In this manner information such as student materials, diagnostic tests, and support materials are sent from the server to the student's computer. Likewise, information such as profile data and test results may be sent from the student's computer to the server through the internet.

I. System Database

The E-learning software combines a number of online tools within a system database to help prepare students for taking a standardized test such as the MCAT. The system database includes information on an analysis of previous administrations of tests, a Question Pool of questions written by an Expert which preferably may be used to create diagnostic tests, and study resources for studying the material that will be on the test.

A. Information Organization

The information within the system database may be organized based on a Section-Subject-Topic-Module-Concept hierarchy.

For the MCAT the Sections are the subtests of the MCAT: Physical Sciences, Biological Sciences, Verbal Reasoning, and Writing. The information hierarchy including Subject, Topic, Module, and Concept for the Physical Sciences and Biological Sciences are shown and described in Table 1 below.

Within the Verbal Reasoning Section, the Modules are Humanities, Social Sciences, and Natural Sciences. Within the Humanities Module are the Concepts of Architecture, Art and Art History, Dance, Ethics, Literary Criticism, Music, Philosophy, Religion, and Theater. Within the Social Sciences Module are the Concepts of Archaeology, Business, Economics, Government, History, Political Science, Psychology, and Sociology. Within the Natural Sciences Module are the Concepts of Astronomy, Botany, Computer Science, Ecology, Geology, Meteorology, Natural History, and Technology.

B. Analysis of Test

The system database preferably includes information gained from an analysis of Practice Tests or Actual Tests offered by the Testing Entity. For the MCAT, these tests are the AMPTs (AAMC MCAT Practice Test). It should be noted that the AMPT practice tests are not allowed to be duplicated in any manner. These tests are the gold standard and are actual tests given during prior MCAT administrations. The database includes information gained from a full evaluation of each question of each available AMPT practice test. If desired, the analysis may go beyond the analysis provided by the Testing Entity. This analysis is used in combination with the information provided by the AAMC in the MCAT Student Manual. The analysis allows the system to create Assessment Tests, Content Review Tests, Interactive Tests, Concealed Skills Tests and Mock Tests that are very similar to the actual MCAT in subject matter, level of difficulty, and question/answer format. This allows that system to customize the student's student plan to optimize performance on the standardized test.

The analysis preferably includes information for a plurality of fields for each question. The fields for the analysis preferably include which version of the AMPT the question comes from (for example AMPT 3R, 4R, 5R, 6R, 7, 8, etc. or the computer based versions or other versions), which Subtest of the AMPT the question comes from (for example Physical Sciences, Biological Sciences, or Verbal Reasoning), which passage number the question comes from, and what the question number is. The fields may also include information on the actual answer of the question, and the level of difficulty of the question. The analysis may also include a field for the question format type, for example, whether the question includes a passage or no passage.

The analysis may also include a field for the general question presentation type. The general question presentation for the Verbal Reasoning subtest may include application, evaluation, comprehension, or new information. The general question presentation for the science subtests may include information, research, problem solving, and persuasion.

The analysis may also include a specific question presentation. The specific question presentation for the Verbal Reasoning subtest may include application-interpretation of hypotheticals, application-solving of problems, application-theory or models, evaluation-accuracy, evaluation-credibility, evaluation-consistency, evaluation-relevance, comprehension-inference from passage, comprehension-information from passage, new information-alternatives, new information-challenges, new information-modifications, or new information-relationships. The specific question presentation for the science subtest may include prior knowledge, passage chart/graph, passage reading, passage experiment, passage data, or passage equation.

For questions which are identified as part of the Verbal Reasoning subtest, the fields preferably also include the Topic and Module, as described by the information hierarchy outlined above. There may also be fields related to a Concept level for each Verbal Reasoning Module. These Concept level fields may include Concepts/theories/hypotheses, vocabulary, readings/essays, and links/references.

For questions identified as part of a science subtests, the following fields are preferably tables included: figures present, chemical equations present, math equations present, experiments present, hypotheses/theories present, text extensive, and esoteric content present. The information in each of these fields may be a Yes or a No based on whether the listed element is present in any particular question. The analysis preferably also includes the Topic, Module, and Concept for each question.

For all questions the analysis preferably includes a field for stem option analysis, option elimination analysis, question structure analysis, answer location, and solution to the answer. The stem option analysis may be broken down further into the following fields: camouflage and distractions, best options, and three or more step analysis. The option elimination analysis may be broken down further into the following fields: dichotomy of options, three out of four options, similar pair options, guess question, internal inconsistency of options, complex sounding options, mutually excluding options and illogical sequence of options. The question structure analysis may be broken down into the following fields: basic positive question, negative question, and multiple multiple choice question. The answer location field may be further broken down into the following fields: Concept/idea-stated, Concept/idea-non-stated, passage-nothing from passage, passage-examples/explanations, passage-central thesis, passage-other contentions, reference-rephrased in stem, reference-direct in passage, reference-specific in passage, reference-diffuse in passage, sentence-first, sentence-last, and sentence-other.

For all questions, the analysis may also include a solution to the question. This solution may include references to the Concepts that are discussed in the question and be linked to any relevant study resources. The solution may also include a complete discussion of the solution to the question. The solution may also include an identification of any test taking skills which may be related to the question.

C. Question Pool

The Question Pool is the source of questions for the diagnostic tests created by the system. These diagnostic tests include the Assessment Tests and Review Tests. The Assessment Tests may include a Pre-Test, at least one Post-Test, at least one Mock Test. The Review Tests may include at least one Content Review Tests, at least one Interactive Tests, and at least one Concealed Skills Tests. This Question Pool is created to provide nearly unlimited combinations of diagnostic tests created by the system. The questions may be obtained from any source, however in the preferred embodiment the questions making up the Question Pool will be created by an Expert based on specific test content of the standardized test. The Question Pool may also include questions on higher order thinking skills and specific test taking skills of the standardized test. Preferably an analysis of actual tests, e.g. for the MCAT the AMPT or MCAT itself, is done to determine frequencies of each of the categories identified for the questions, as in the listing of fields done for the AMPT above, and then the questions are constructed proportional to these frequencies as possible.

Each question in the Question Pool preferably includes several fields and attributes that are entered into the system database. These fields and attributes contain information about the question that may be used in conjunction with the analysis of information provided by the Testing Entity to create diagnostic tests. The Question Pool fields may include information on level of difficulty of the question, the question format, the question type, the subject of the question, the higher order thinking skills invoked by the question, and the test taking skills invoked by the question. Preferably, the use of the questions in the Question Pool is managed such that the questions will automatically be removed from the pool of potential questions for a particular student once they have either successfully answered the question on two occasions or incorrectly answered the question on two occasions.

D. Study Resources

The system database may also include study resources. The study resources may include content materials on each Concept, Flashcards, Equations, Glossary, Audio Recordings, Video Recordings, Text Messaging Tool, Flag Tool, and Comment Tool. The study resources are described in more detail below. Preferably, the configuration and components of the study resources lead to the optimizing of learning the information for the optimization of test-taking.

E. Priority

The importance of the information within the system is may be ranked based on a Priority System. The Priority System is preferably determined by Expert and entered into the database. The Priority levels may be determined based on the evaluation and analysis of actual tests, when available, and on the public information provided about the test by the Testing Entity. The Priority System is a constant reminder of what the student should focus on and know. Priorities are determined and displayed for Concept, Flashcard, Equations, and Glossary items.

The Priority System ranges from four stars to one star. Four stars indicate that the item is “Must Know” information. The student should do everything they can to know and use this information. All students, including those with relatively lower goal scores must know these items. Three stars indicate high importance. This information is very important for high goal students and of some importance for low goal students. Two stars indicate moderate importance. This information may be a lower priority in studying and the student may move on to this information only after the four star and three star information is mastered. Information marked with two stars is of some importance to high goal students, but of low importance to low goal students. One star indicates a low level of importance. These materials should not be focused on by most students. High goal students should be aware of this information, but low goal students do not need to study this information.

The level of importance may be determined by an Expert. All of the study material in the database may be keyed with the Priority System. This includes the information on each Concept, Flashcards, Equations, Audio Recordings, Video Recordings, etc.

The Priority System may aid the student in achieving Automaticity. Automaticity is the learning of information until it is second nature. This may be achieved by repeatedly practicing and learning the information. Automaticity is an important concept necessary for proper long-term memory storage and effective use of working memory during test-time. The information indicated with four stars should be “automatic” knowledge for the student.

II. System Structure

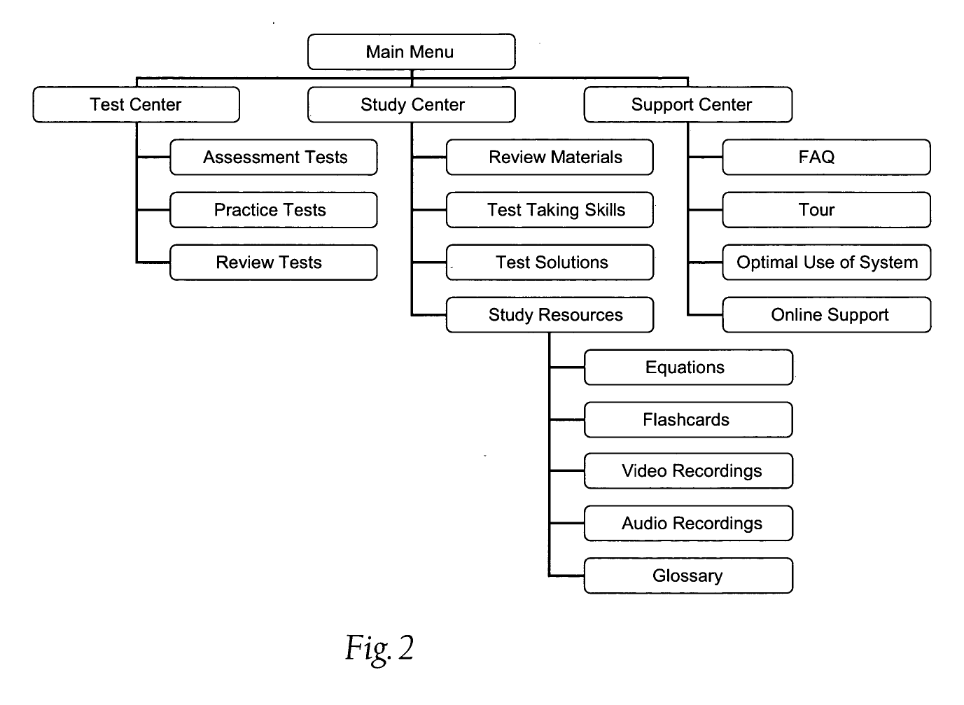

The system preferably includes a main menu preferably includes links to a Test Center, a Study Center, and a Support Center, as shown in FIG. 2.

A. Test Center

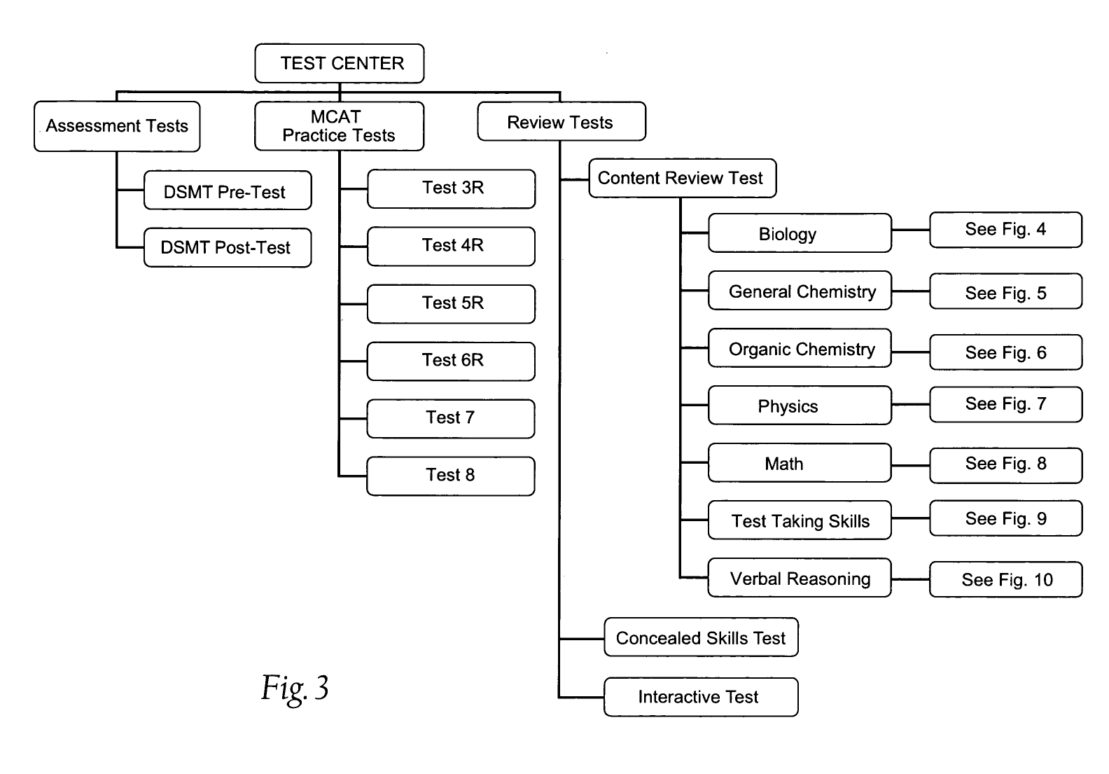

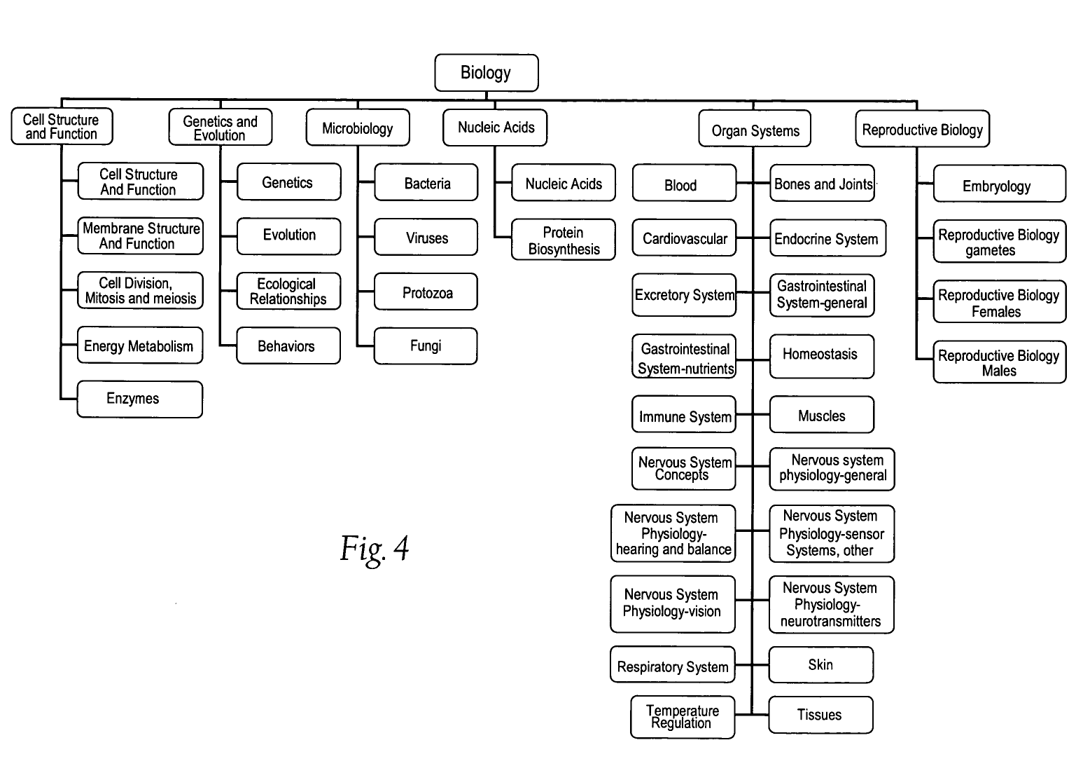

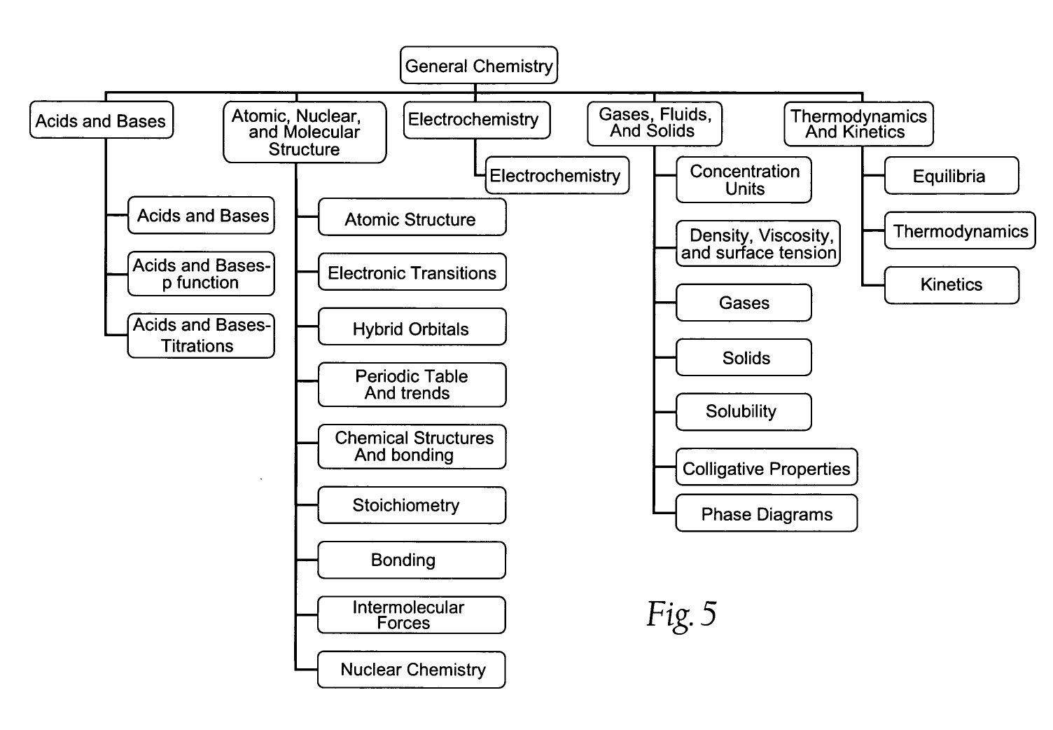

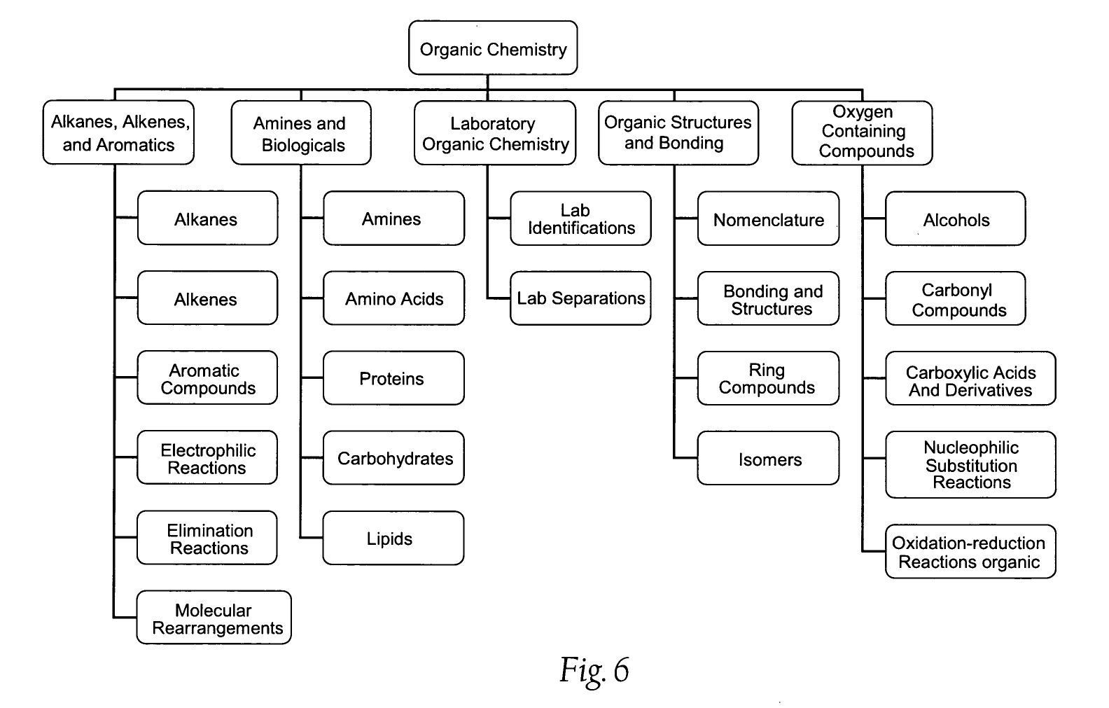

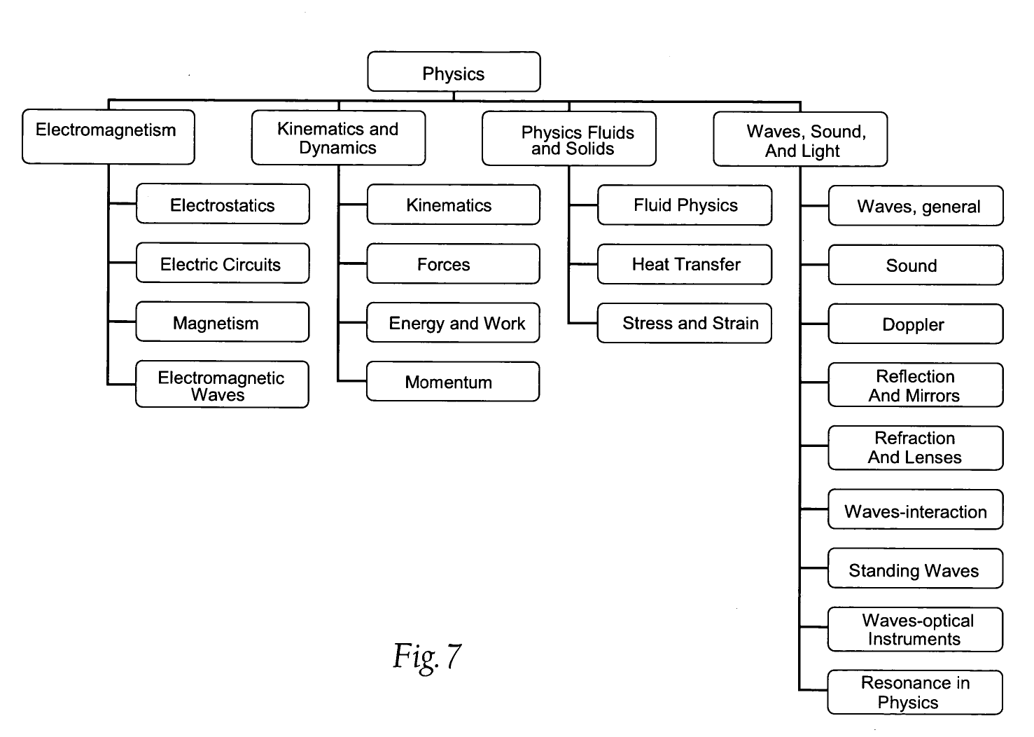

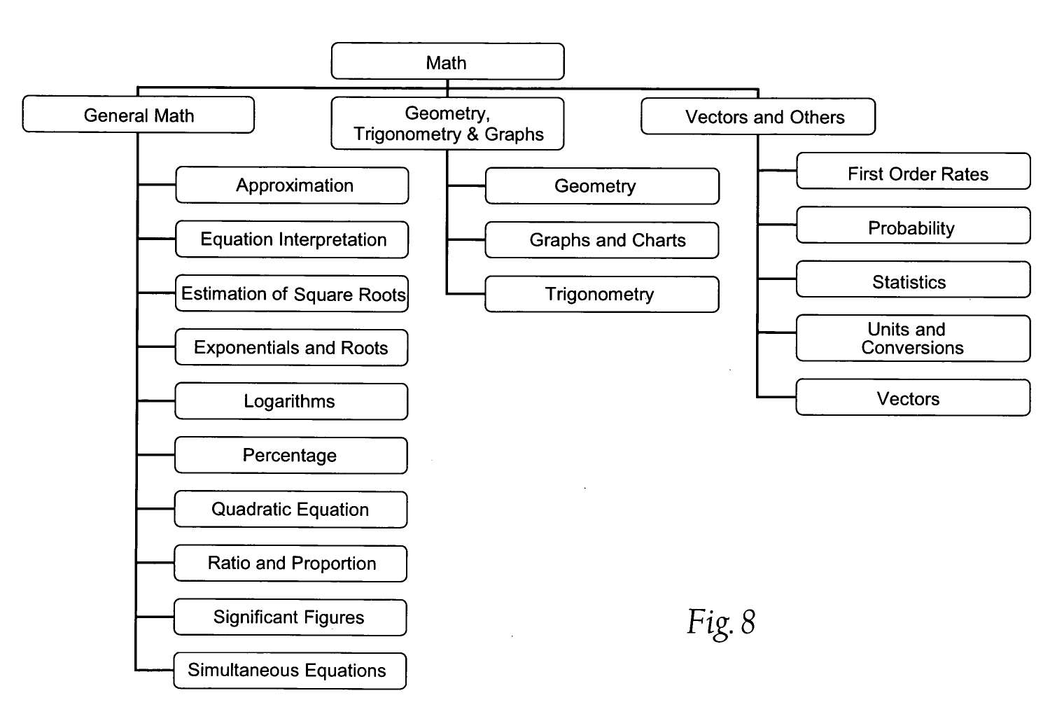

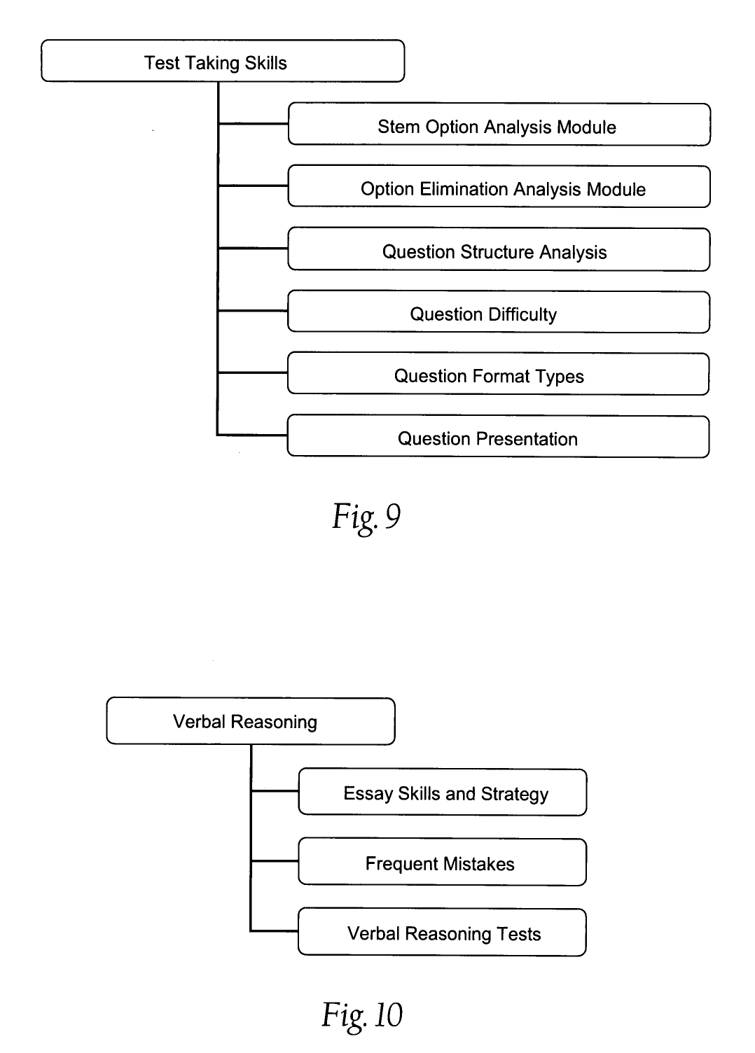

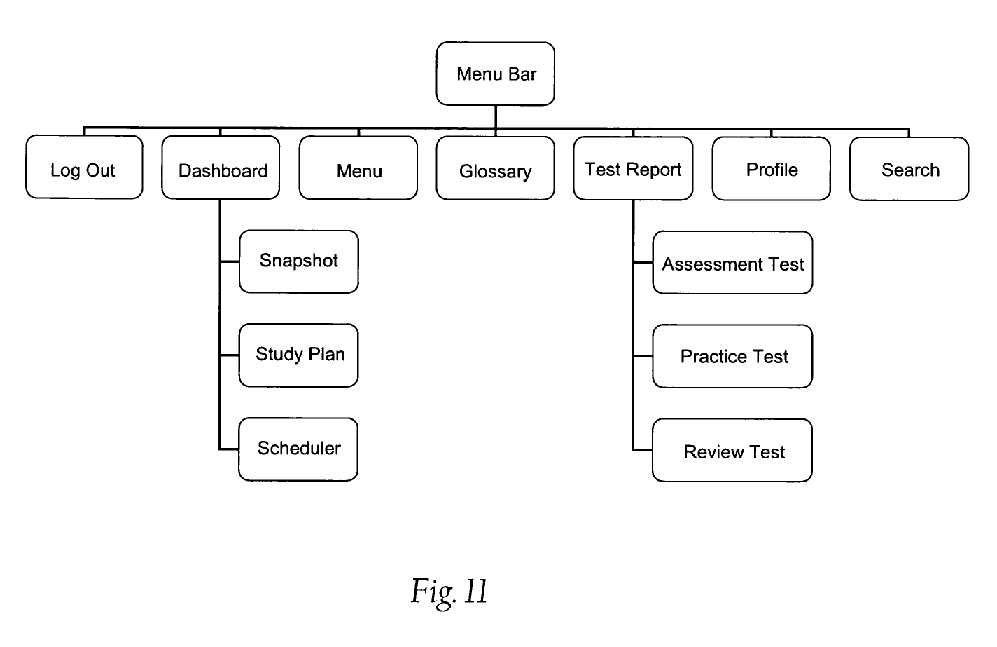

The Test Center may provide access to all the diagnostic tests in the system. The diagnostic tests provide specific evaluation of specific test content and specific test taking skills needed by the student. The Test Center preferably provides three different types of diagnostic tests: Assessment Tests, Practice Tests, and Review Tests, as shown in FIGS. 3-10.

Preferably, the diagnostic tests will be administered online as computer based tests. This allows the system to instantly analyze the student's performance on each diagnostic test and update the student's Study Plan based on those results. The system may also use the results of the diagnostic tests to update the progress monitoring and feedback, for example the information which will be described further in the Dashboard and Test Report Center.

i. Assessment Tests

The Test Center may include Assessment Tests. The Assessment Tests are available to measure the level of knowledge of the student and track the student's progress. For the MCAT there may be a DSMT (diagnostic Science and Math Test) Pre-Test and at least one DMST Post-Test. The MCAT test preparation may also include at least one Mock Test.

a. DSMT Pre-Test and Post-Test

The DSMTs are designed to measure the level of knowledge in the content areas deemed pertinent by the Testing Entity, and/or the exam preparation Expert. Any single AMPT does not usually contain all of the possibly content areas which may be tested. The DSMTs are specifically created by the exam preparation Expert to meet these needs. The DSMTs may be static tests created by an Expert, or the DSMTs may be dynamic tests created by the system. In a system created DSMT, the Expert may create an algorithm which pulls questions from the Question Pool to create each DSMT. For this reason the DSMT is categorized similarly to the AMPT. In this manner the DSMT can be fit to test the areas that the AMPT, and therefore the MCAT tests.

Each question of a DSMT is linked to the system database and includes a number of fields and attributes specific to that question. The fields for the DSMT may include the question number, the question stem, the answer options, the actual answer, and a discussion of the solution. The fields for the DSMT may further include the question difficulty. It is contemplated that the question difficulty may be automatically updated by the system based on student performance on that particular question. Preferably if 0-50% of students get the question correct the question is hard, if 51%-75% of students get the question correct it is moderate and if greater than 75% get the question correct it is easy. The fields for the DSMT may further include a certainty of answer percentage. This may range from 100% for a student that is 100% sure of the answer to 0% for a student who is simply making a guess at an answer. The fields for the DSMT may further include the question format, for example whether the question is a stand alone question or a mini-passage format. The fields for the DSMT may further include the question type, for example whether the question is knowledge, problem solving, mini-passage reading, mini-passage chart/graph, mini-passage experiment, Concept comprehension-single, Concept comprehension-intra, Concept comprehension-inter, or any combination thereof. The fields for the DSMT may further include the question subject based on the organizational hierarchy, for example, the Concept the question relates to. The fields for the DSMT may further include the test taking skills required for the particular question. The fields may further include higher order test skills such as analysis, inference, evaluation, and comparison.

The created test will then be drawn from the Question Pool, the student may take the test, the student may save the test if desired, and when completed an analysis will be done and reported in the Test Report Tool. It is also contemplated that students could have the option of selecting questions from the pool of questions based on the database hierarchy and fields. E.g., if a student only wants to be tested on Biology, he/she will have that option.

B. Mock Tests

The Test Center may also include Mock Tests. The fields and attributes of the questions that make up the Mock Tests are the same as that discussed above. The Mock Tests is preferably generated based on student input. For example, the student may be able to choose the number of questions they want, the level of the hierarchy they want, the questions to come from, and the Section, Subject, Topic, Module or Concept they want the questions to come from. It is further contemplated that the student may be able to choose to draw questions from any the various fields, in any combination. For example the student may choose to take a Mock Test with 100 questions drawn from the Subject of Biology. The student may further choose whether they want questions from Content Review Questions, Interactive Questions, or Concealed Skills Questions. The Content Review Questions are designed to assess the student's comprehension of content. The Interactive Questions assess the student's application of knowledge to the real test. The Concealed Skills Questions assess various skills associated with test taking. The created test will then be drawn from the Questions Pool, the student may take the test, the student may save the test if desired, and when completed an analysis will be done and reported in the Test Report Tool.

ii. Practice Tests

The Test Center may also include Practice Tests. Preferably, these Practice Tests are tests provided by the Testing Entity. This may also include Actual Tests that have previously been administered by the Testing Entity. For the MCAT, the Practice Tests are the AMPT. At the present time the MCAT practice tests cannot be duplicated. Therefore the student must take the AMPT either online at the AAMC website or on paper. The student then enters their score in the Test Center. At some point in the future, if the Testing Entity allowed it, the questions from the AMPT could be entered into the system database such that the AMPT could be taken as a computer based test through this system. This would make preparation more efficient as the student would not need to take the AMPT and then separately enter their answers into the system. Currently there are several AMPTs available including AMPT 3R, AMPT 4R, AMPT 5R, AMPT 6R, AMPT 7, and AMPT 8 (and others). It is contemplated that as additional AMPTs are released, they will preferably be added to the system. These have been recently changed to Computer Based Test by AAMC. Any such modification, or future modifications, is easily incorporated into the system. Regardless of the method of taking the Practice Test, once the student's Practice Test answers are entered into the system an analysis of the student's test answers will be completed and saved in the Test Report Tool.

iii. Review Tests

The Test Center may also include Review Tests. The Review Tests may be utilized to teach desired skills or confirm the acquisition of desired skills. The Review Tests may include Content Review Tests, Interactive Tests, and Concealed Skills Tests.

a. Content Review Test

The Review Tests preferably include a Content Review test. The purpose of the Content Review Test is to evaluate how well the student has mastered the content of the Concepts. In a preferred embodiment, for use in preparing the MCAT, Content Review Tests are keyed to the Module level of the hierarchy. In this manner a Content Review Test may be created for each Module. As discussed above, each Module includes at least one Concept. Although the preferred embodiment includes Content Review Tests keyed to the Module level of the information hierarchy, it is contemplated that the Content Review Tests could be keyed to any level of the hierarchy. In this manner, the student could choose to take a Content Review Test of for example, a specific Concept, or of an entire Module, Topic, Subject, or Section.

Each Content Review Test may be a static test created by an Expert and saved in the system database, or the Content Review Test may be a test generated by the system. If the Content Review Test is created by the system, it is preferably that the questions for the Content Review Test be pulled from the Question Pool based on a number of factors including the student's overall goal score, the student's strengths and weaknesses, the and the student's performance history on each particular question. The fields and attributes of the Content Review Test questions is the same as that discussed above for the DSMT Assessment Test. The created Content Review Test will then be drawn from the Question Pool, the student may take the test, the student may save the test if desired, and when completed an analysis will be done and reported in the Test Report Tool.

It is further contemplated that the student may select a Content Review Test based on any of the fields related to the questions. For example, the student could choose to take a Content Review Test comprised entirely of questions that are identified as “Hard.” Alternatively, the student may be able to select a Content Review Test specifying multiple fields. For example, the student may select a Content Review Test comprised of questions identified as “Hard” and also identified as being a part of the electrostatics Module. It should be understood that the student may choose an option from any combination of the fields, or all of the fields to create a Content Review Test.

b. Interactive Tests

The Review Tests may also include Interactive Tests. Interactive Tests are found at the level of the Concept. The Interactive Questions assess the student's application of knowledge to the real test. These are questions which most closely mimic the actual questions found on the standardized test. Test may be a static test created by an Expert and saved in the system database, or the Interactive Test may be a test generated by the system. If the Interactive Test is created by the system, it is preferably that the questions for the Interactive Test be pulled from the Question Pool based on a number of factors including the student's overall goal score, the student's strengths and weaknesses, and the student's performance history on each particular question. The fields and attributes of the Interactive Test questions is the same as that discussed above for the AMPT. The created Interactive Test will then be drawn from the Question Pool, the student may take the test, the student may save the test if desired, and when completed an analysis will be done and reported in the Test Report Tool. Additionally, students may select an Interactive Test from the pool at any level of the database hierarchy or based on any of the fields for the questions.

c. Concealed Skills Test

The Review Tests may further include a Concealed Skills Test. The Concealed Skills Questions assess various skills associated with test taking. The Concealed Skills Test is designed to teach and or confirm the acquisition of desired skills. The Concealed Skills Test may have an emphasis on learning skills and higher order test skills.

The Concealed Skills Test uses a technology whereby a passage or question is presented and the student must determine and complete certain tasks by uncovering the concealed answers. For example, in the Verbal Reasoning Section, the student will be given a passage to interpret; one of the skills the student must develop is the ability to find key words, central thesis, secondary contentions, supporting evidence, etc.

One task may direct the student to highlight the key words in the passage. These are not listed as multiple choices. When the student highlights a word, they will be notified if it is important or not. That is, the answer is concealed until they make a selection. The technology is already present in the preferred embodiment of the MCAT preparation. The Concealed Skills Test may be a static test created by an Expert and saved in the system database, or the Concealed Skills Test may be a test generated by the system. If the test is generated by the system, it is preferable that the questions for the Concealed Skills Test be pulled from the Question Pool based on a number of factors including the student's overall goal score, the student's strengths and weaknesses, and the student's performance history on each particular question. The fields and attributes of the Concealed Skills Test questions are the same as that discussed above for the AMPT Assessment Test. The created Concealed Skills Test will then be drawn from the Question Pool, the student may take the test, the student may save the test if desired, and when completed an analysis will be done and reported in the Test Report Tool. Additionally, students may select a Concealed Skills Test from the pool at any level of the database hierarchy or based on any of the fields for the questions.

d. Test Taking Options

For any of the tests offered online within the system, there are preferably three different modes of taking the test. The different modes can be used to enhance the assessment of the student and therefore enhance the student's test preparation. Normal mode is available for initial profiling. There is no time factor in Normal mode. Timed mode is available to assess certainty and speed of knowledge attained. Timed mode assesses the time required per question in order to improve the speed of test taking. Booster mode is available for distractions and for increasing ability to function under pressure. Booster mode may help the student get ready for possible test conditions and to practice improving speed and time of question completion. Booster mode is a timed test in which each question must be answered within a predetermined amount of time. The predetermined amount of time may be set by the student, or may be preset in the system. The Booster mode may also include options for the student to add to create anxiety and distractions such as such as noise, video, voices, etc.

For each test offered online within the system, there are multiple options available for completing the test or coming back at a later time to allow the student to make the most efficient use of their time. For example, the student may save the test at any time to save their answers in the system database. The system preferably also includes a finish option. When the student chooses the finish option, it indicated to the system that the test report should be generated. The system preferably also includes a jump option. The jump option allows the student to jump between questions that they have not yet answered.

For each of the diagnostic tests, the system processes the student's answers and generates a report which is stored in the system database and is accessible for reports and other operations.

iv. Alternative Embodiment

It is also contemplated that the Test Center be divided into an initial Assessment Center and an ongoing Test Center during the actual study. The Assessment Center would include components for use during an initial and comprehensive student assessment which includes content, test-taking skills and non-content skills and factors.

For example, a non-content assessment would include epistemological beliefs, use of learning strategies (e.g., note-taking, summarizing, comprehension monitoring, identification of important information or mnemonics), understanding of higher order thinking skills (as for Quellmalz for evaluation, inference, comparison or analysis), learning mode (e.g., visual, auditory, kinesthetic) motivational factors, anxiety factors and metacognition. Non-content would also include an analysis of effective learning techniques (e.g., internal organization, meaningful learning, elaboration, self-regulated learning, automaticity and problem solving. The definition of these terms are standard and are assumed as defined in standard texts on learning theory such as Human Learning, Ormrod, 4^{th} Edition, Pearson/Merrill Prentice Hall, 2004.

B. Study Center

The Study Center provides immediate access to all of the components and subcomponents of the test content and test taking skills specific to the test being studied. For the MCAT, this may include Physical Sciences, Biological Sciences, Verbal Reasoning/Writing, and Test-Taking skills. The Study Center may also include a plurality of study resources.

It may be desirable to allow the student to view the information contained in the Study Center in various manners. For example, the student may view the resources by Content area, by list, by Flag, by Comment, by Priority, or by Schedule. It is further contemplated that the resources may be viewed by additional manners which may include Community Comments or Student Generated Comments. All information in the database is maintained with these markers such that the student may change the organization of the Study Center information at any time.

For the MCAT the information is preferably organized by Concepts. The information is organized consistent with the previous hierarchy of Section, Subject, Topic, Module, and Concept.

These are additional means to provide a comprehensive in-depth review for the student. Each of the items shown is linked to its Concept via the system database. This is done by an Expert. Then algorithms will access the item whenever its key Concept is discussed or referenced by other Concepts.

i. Concept Content Presentation

Preferably, the study resources include a detailed content presentation of each Concept. In the preferred embodiment the presentation is located to the left of the screen and may include diagrams when applicable. It is contemplated that some of the diagrams may be animated or interactional. The screen may further include scroll bars to ease navigation of the study resources. The screen may also include a button the student may click to enlarge the screen or a section thereof for easier reading and study. It is contemplated that there may be several related Concepts within a Module. For this reason, it is contemplated that when a diagram is enlarged, it may remain enlarged for review with other content within the same Module. It is further contemplated that to the right of each content area may be an area providing links to additional study resources to amplify and support the content. Preferably each of these study resources may be clicked and a pop-up screen will give additional information to the user. The additional study resources may include, but are not limited to links to Important Terms, Related Concepts, Related Equations, and Related Flashcards.

The system may further provide a link to all the related Concepts for a given Module. For example, the Concepts within a Module may be shown as a series of page icons. It is contemplated that when the student moves their mouse or cursor over each page icon the description of the icon, for example the Concept description, will pop-up.

When relevant, a button may be present to allow the activation of an Audio Recording of the content. When relevant, a button may be present to allow the activation of Video Recording of the content. These Audio and Video Recordings are stored in the system database and are linked to the Concept. It is also contemplated that there may be a button present to print the Concept.

A student may use the Flag or Comment features at any time. These features are described in more detail below. The Flag feature is used to remind the student to recheck the Concept. The Flags are maintained in the system database and are accessible from the Dashboard or the Study Center. The Comment feature is used to add whatever information the student wished to the Concept. This may be anything that the student feels will aid their study and may include a reminder, a reference, or an additional detail. The Comments are preferably stored in the system database and may be accessible from the Dashboard or the Study Center.

It is also contemplated that the student may use the Text Message Tool to send information to a portable receiving device. The Text Messaging Tool will be described in more detail below.

It is also contemplated that the student will be able to access comments and suggestions on the Concept made by other students, advisors, teachers, mentors.

It is also contemplated that the student may be able to further personalize, individualize and incorporate the Concept by creating Student Generated Content. A button, beyond the Comment button may allow and prompt students to learn the Concept in more depth by using the following prompts: Seen Before, Use in Daily Life, Makes Me Think Of, Other Related Information To Find, Questions for Peers, Questions for Instructor/Parent/Advisor, Summarization of Content, Images of Content, Possible Research Project, Predictions Based on Information, How to teach someone older/younger, Auditory Summary of Content.

It is also contemplated a “Confidence Level” button may allow the students to select a level of confidence from 100% confident in understanding the material to 0% confident. This would then be stored as one of the display options in the Study Center the student could refer to for review. It is further contemplated that the “Confidence Level” could be stored in the system and displayed in the Dashboard.

It is also contemplated to include an “Automatic Review Date” button may allow the student to select a date for the system to remind them to review the Concept again.

It is also contemplated to include an “I Have a Question” button for Peers, Instructors, Parents, Tutors, or Mentors to be contacted. This will allow the student to immediately send a question to these individuals. Then receive a response related to the Concept. All of these would be stored and accessible from the Study Center.

The content review screen may further include an option to take a Content Review Test, Interactive Test, or Concealed Skills Test for that Concept. The student will also have the option of being tested at a higher level of the hierarchy (e.g., at the Topic level) or by specific fields (e.g., higher order test skills). Preferably, the student may go directly to the Content Review Test by clicking a button on the content review screen.

ii. Test Taking Skills

The study resources will also include information on specific test taking skills important to the standardized test the student is preparing for. The specific test taking skills may be those identified or described by the Testing Entity or may be identified by a test preparation Expert. For the preferred embodiment, the MCAT prep, the test taking skills may relate to question stem analysis, option elimination analysis, question structure analysis, question difficulty, question format types, question presentation, and answer location. The specific test taking skills give the students tips on how to address questions on the standardized test. They are then applied and further demonstrated in the explanations to the solutions of real tests as in the next section.

iii. Explanations of Actual Tests

The Study Center may also include detailed explanations of actual standardized test questions or of the closest simulated test questions if actual tests are not available. In the preferred embodiment, these are found in “MCAT Solutions” provided by the Testing Entity. Preferably, these explanations are prepared by an Expert and are independent of any explanations provided by the Testing Entity. The explanations preferably include three sections: What to Study, Answer Discussion, and Test Taking Skills. “What to Study” identifies the specific content that the student must know in order to answer the question. “Answer Discussion” provides a detailed analysis of how the question was answered. “Test Taking Skills” identifies the test taking skills that are related to this question. These explanations show the student what information to recall, how to comprehend the info in the passage, how to interpret data in the passage, how to recognize and apply the required Concepts and how to evaluate the methods, etc presented and determine consistency.

If applicable, the explanation may include a button to activate an Audio Recording. If applicable, the explanation may include a button to activate a Video Recording. As described above with regard to the content presentations, it is further contemplated that to the right of each explanation may be an area providing links to additional study resources to amplify and support the explanation. Preferably each of these study resources may be clicked and a pop-up screen will give additional information to the user. The additional study resources may include, but are not limited to links to Related Concepts, Important Terms, Related Equations, and Related Flashcards.

iv. Additional Resources

A number of other resources may be available for study. These resources may include a Glossary, Equations, Flashcards, Audio Recordings, Video Recordings, Ancillary Reading Materials, and Text Messaging. Each of these resources is linked to a Concept in the system database. The determination of the linking is preferably determined by an Expert. Preferably when each Concept is viewed, a link to the available resources is present.

a. Glossary

Glossary items are created by the Expert based on the specific test content and specific test taking skills for the standardized test. They are usually words but may be Concepts, phrases, equations, laws, etc. A description is created for each term in the Glossary that complements/supplements that found in the Concept itself. The Glossary tool is present in the menu bar at the bottom of all screens and has a search function. Students may access this at any time without leaving their screen. A pop-up appears with one or more items for the student to select based on the search. The student then clicks on one of these and a second pop-up box appears with the information about the item. The student may apply a Flag to an item if desired or print it. The student may also apply a comment to each Glossary item. Each Glossary entry may have a priority attached to it. The priority is preferably determined by an Expert according to the Priority System described below. The Glossary items will serve as sources for Flashcards. The student may choose to have the Glossary items organized by Concept identifier, by Priority, by Flagged item, or by Commented item. In this manner; the student may easily identify the information that is most important for them to study.

The Glossary is intended to provide a means of rapid review of all important vocabulary and Concepts presented in the specific test content and the specific test taking skills. The Glossary items are preferably all keyed to the same level of the information hierarchy. For the MCAT, The Glossary terms are keyed to the Concept level of the information hierarchy. Further, the student may use the Text Message option to send the Glossary item to a portable receiving device, as is discussed in further detail below.

b. Equations

The Study Center may also include Equations. The Equations are a means of rapidly reviewing all of the equations and their related Concepts. The Equations are preferably created by an Expert based on the requirements of the particular standardized test. In the case of the MCAT, the Equations cover all types of equations including math, physics, general chemistry, organic chemistry and biology. For the MCAT, the Equations are keyed and linked to the Concepts level of the information hierarchy.

Each Equations entry has four components for the student: 1) the equation, 2) definition of terms/parameters, 3) what information is directly assessable by correctly interpreting the Equation, 4) what are the important Concepts not in the equation but necessary to fully understand it and use. Preferably the Equations are presented in a format such that the equation itself is always visible in the top space of a two space box, while each of other components will be visible one at a time. The box may include a button for each component such that when the corresponding button is clicked the component is revealed in the space. However, it is also contemplated that any combination of the components could be shown on the screen at any one time.

The priority level is assigned to each equation and it will be accessible from the Study Center. Any Equation may be flagged and printed. The student may print a single Equation, or an entire set of Equations based on the Concept. The Equation appears in a pop-up box without leaving the student's screen, such that the student may rapidly review it and return to their study.

The student may also apply a Comment to each Equation. Each Equation may have a priority attached to it. The priority is preferably determined by an Expert according to the Priority System described below. The Equations will serve as sources for Flashcards. The student may choose to have the Equations organized by Concept identifier, by Priority, by Flagged item, or by Commented item. In this manner, the student may easily identify the information that is most important for them to study. Further, the student may use the Text Message option to send the Equation to a portable receiving device, as is discussed in further detail below.

c. Flashcards

The Study Center may also include Flashcards which are created automatically from the Equations and from the Glossary items. The system takes each of these Equation and Glossary items and converts it into a Flashcard connected to each Concept. Preferably, an algorithm takes each Glossary item and generates a question of “What is . . . ” for the question part of the Flashcard. The Glossary content then becomes the answer part of the Flashcard. The algorithm preferably takes each equation and writes the symbolic equation, the description of the symbols, the literal interpretation of the equation and key concepts of the equation. Preferably, each of these elements has been entered into the database by the Expert. The Flashcards are intended to amplify content and provide a means of rapid review of vocabulary, equations, and Concepts. The Flashcards algorithm will result in a question on one side of the card and the answer/solution on the other. The Flashcards may be electronically flipped by a button on the screen. The student may select any Flashcards they want or a whole set tied to the Concept. These may then be printed individually or in sets. The Flashcards appears as a pop-up on the screen. The student may apply a flag to any or all of the Flashcards. The student may also apply a comment to any or all of the Flashcards. Each Flashcard may have a priority attached to it. The priority is preferably determined by an Expert according to the Priority System described below. The Flashcards and the priority levels are both accessible from the Study Center. The Flashcards may be retrieved by the Concept identifier, by Priority, by Flag, or by Comment. Further, the student may use the Text Message option to send the Flashcard to a portable receiving device, as is discussed in further detail below.

d. Audio Recordings

The system may also include Audio Recordings. The Audio Recordings are sound recordings of the text found in the Concepts and the test solutions, which in the preferred embodiment is the “MCAT Solutions”. The Audio Recordings may be created by a professional voice or an Expert and follow the text as found in the Concept with some modifications for clarity. The Audio Recording is linked to the system database by Concepts. A student may use the recording in any manner they would normally be able to use a recording (i.e., listen to it on the computer, make a CD/DVD, send it to another listening device, etc). The Audio Recordings are preferably accessible from the Study Center. The student may apply a flag to any or all of the Audio Recordings. The student may also apply a comment to any or all of the Audio Recordings. Each Audio Recording may have a priority attached to it. The priority is preferably determined by an Expert according to the Priority System described below. The Audio Recordings and the priority levels are both accessible from the Study Center. The Audio Recordings may be retrieved by the Concept identifier, by Priority, by Flag, or by Comment. Further, the student may either record the Audio Recordings on a CD/DVD or other recording medium, or the student may send the Audio Recordings to a portable device for use at another time.

e. Video Recordings

The system may further include Video Recordings. The Video Recordings are video recordings of the text found in the Concepts and the test solutions, which in the preferred embodiment is the “MCAT Solutions”. The Video Recordings may be created by a professional or an Expert and follow the text as found in the Concept but supplemented by visuals. By way of example, and not to be limiting, the visuals may include PowerPoint or equivalent, on screen or board print/writing by Expert. Some Video Recordings will be simply PowerPoint presentations with a recorded voice over. Others will be actual videos of various types, for example video of a professional or an Expert doing actual teaching. Some may be simple “documentaries” as available. The Video Recordings are linked to the system database by Concepts. A student may use the recording in any manner they would normally be able to use a recording (i.e., listen to or watch it on the computer, make a CD/DVD, send it to another viewing/listening device, etc). The Video Recordings are preferably accessible from the Study Center. The student may apply a flag to any or all of the Video Recordings. The student may also apply a comment to any or all of the Video Recordings. Each Video Recording may have a priority attached to it. The priority is preferably determined by an Expert according to the Priority System described below. The Video Recordings and the priority levels are both accessible from the Study Center. The Video Recordings may be retrieved by the Concept identifier, by Priority, by Question, by Flag, or by Comment.

f. Ancillary Reading Materials

The system may further include Ancillary Reading Materials. The Ancillary Reading Materials are mainly for the Verbal Reasoning but may be used with any of the subjects. These are suggested readings or links to readings which will help the student improve their reading and interpretation skills. Their goal is not to increase the student's knowledge base. They will be accessible from the Study Center. They are entered linked to the Concepts in the system database.

Ancillary Reading Materials may be created or referenced to provide samples for enhancement of the skills, especially reading, comprehension and interpretation, related to each of the subtests. The Ancillary Reading Materials may be selected by references/links to commercial magazines, newspapers, etc. The Ancillary Reading Materials may be created by Experts consistent with the descriptions provided by the Testing Entity, by analysis of actual test questions/passages, understanding of the specific test content and specific test taking skills of the standardized test. The Ancillary Reading Materials may be keyed, via the system database, to specific test content or specific test taking skills. The Ancillary Reading Materials are preferably linked to the Concepts in the system database.

g. Text Messaging Tool

The system may further include a Text Messaging tool accessible from the Study Center as a Resource. The Text Messaging tool will allow the sending of selected information from the Question Pool, Glossary, Flashcards, and/or Equations to a portable receiving device by text messaging or by email or any other means available. Preferably the student will be able to choose the source of information they want to receive. The sources of information may include the Question Pool, Glossary, Flashcards, Equations, or any combination thereof. The student may further choose which information they wish to receive. An algorithm is written to allow the selection of that specific content which will be most important and beneficial for the student to review. The student may choose to receive random information, information based on priority system, information based on flag applied by the student, information based on comments applied by the student, information based on the most recent diagnostic test taken by the student, information based on the Study Plan prepared by the system, information based on the schedule set by the student, or information based on a specific Subject, Topic, Module, or Concept. The student may further choose how long they wish to receive information for, how many times per day they wish to receive the Test Messages, and the device to which they want the information sent to.

h. Comment Tool

The system may also include a Comment Tool. The Comment Tool is a means for a student to supplement their knowledge of content and skills as they desire. It may also be desirable to use the Comment Tool to provide a means of having interactions with and knowledge of what other students are doing or are concerned about. The Comment button is available in each Concept presentation. When the student clicks it, a pop-up screen appears which reveals all prior comments for that Concept by all other students. The Comment pop-up screen also provides a space for the student enter a new comment. The Comment Tool can be used for any purpose. All the comments are accessible from the Study Center and from each Concept screen. The comments are stored in the system database tied to the Concept. The student also has a running record of the number of Comments in their database.

i. Flag Tool

Flag tool is preferably provided for the Concept, the Flashcards, the Equations and the Glossary. Once a student clicks the Flag tool, it is stored by the system database linked to that Concept, etc. The student has a running record of the number of flagged items in their Dashboard. The student may access their Flags from the Study Center. The Flags may used for any purpose by the student, but a common use is to note those areas the student wants to track for continuing study.

C. Support Center

The Support Center contains the mechanisms for the student to manage monitoring, feedback, and communication. The Support Center helps to motivate and encourage students in their test preparation process. The Support Center may also provide a mechanism for the students to contact and interact with the developers of the system.

The Support Center may include a tour of the system to explain to students how to use the system. The Support Center may further include a listing of frequently asked questions (FAQ) along with answers to those questions.

The Support Center may also include an “Ask the Expert” function. The “Ask the Expert” function will allow students to submit questions to an Expert. The questions may then be categorized and will be answered by an Expert. Preferably the questions will be answered within 24 hours. Preferably, the Expert is an individual who has worked in field an extended period of time, has written or taught students the standardized test, has written questions for the standardized or any combination of these. It is further contemplated that the Expert may be one person, or a plurality of people. It is also contemplated that the Ask the Expert function may also permit a time to be set up for peer groups to interact the Expert. Live times may also set up in a forum like session for interactions between the Expert and the students.

The Support Center may also include a “Trouble Ticket System.” The Trouble Ticket System allows the student to submit problems online. The staff will respond to tickets related to their areas.

Peer Study Groups are found in the Study Center and are set up by the students. They have the option of conferencing between themselves in a chat type forum, meeting with an Expert via the “Ask the Expert”, or meeting in the conference mode as per Glance or others. The Peer Study Groups may allow the students to designate a study group of peers. The students may then determine which times the groups will meet. The Students may then meet via a commercial system such as Glance or any other conferencing system. The conference preferably includes audio, video, text messaging via the computer screen, or any combination thereof.

It is also contemplated that for some standardized testing preparation an online learning community may be a component of the Support Center or a separate Communications Center. This may include a site where all stakeholders including students, parents, teachers, advisors, mentors, tutors can meet and communicate with the single purpose of enhancing learning by the creation of a community of learners.

Used together with the Dashboard and the Profile, the Support Center helps to provide motivation, social support, general support, and feedback to students.

D. Communications Center

In an alternative embodiment, the system may also include a Communications Center. In this embodiment, the Communications Center could include some of the interactional components described above with respect to the Support Center, for example the online component. The Communications Center may include additional means of interaction. For example, the Communications Center may include a live on-line website to create a community of learners. The Communications center may also include other known internet communications methods including, but not limited to message boards, chat rooms, and online forums.

E. Progress Center

In alternative embodiment the system may also include a Progress Center. The Progress Center would incorporate progress tracking components which are described below with respect to the Dashboard and Test Report.

F. Menu Bar

The system preferably includes a menu bar which is available from all screens. The menu bar may include logout, Dashboard, menu, glossary, test results, profile, help, and search tools, as shown in FIG. 11. As the system evolves, other components may be logically added compatible with the ease of navigation and time efficiency of preparation concepts.

i. Logout

The logout tool allows the student to logout of the system from any screen. Preferably the student can click on the logout icon at any time, from any screen.

ii. Dashboard

The Dashboard Tool may provide immediate and running feedback to the student on their test preparation. As stated above the Dashboard is preferably available from all screens. In the preferred embodiment the Dashboard opens in a separate window, such that when the student is finished using the Dashboard they may close the Dashboard window and return to their previous activity. The Dashboard may include a snapshot view, a Study Plan view, and a scheduler view.

a. Snapshot View

The snapshot view provides a quick summary of how the student is doing in their preparations. The snapshot view is preferably the default view shown when the Dashboard icon is clicked. The snapshot view may include information from the student's goals and practice tests. For example, the snapshot view may include the date the student anticipates taking the test; this date may be set by the student in a scheduler function found in the Profile Screen. The snapshot view may also include the days left to the test date. The snapshot may further include the student's goal test score, which may be set by the student in the Profile Screen. The snapshot may show the goal score in each subtest, as well as the sum of the subtest scores. The snapshot view may also show the average goal score of all other students using the system. The snapshot view may further display the student's best practice test score. The snapshot view may further include the number of flags and comments the students have applied. The snapshot view may also include a listing of the weakest and strongest content and skill areas for each of the main hierarchy items. The snapshot view may also include a summary of the student's score in each diagnostic test. The scores of the diagnostic tests are preferably listed in chronologic order. The snapshot view may include the total score as well as the score of each section. The snapshot view may also include the student's percentage score in each subject area of the diagnostic tests. The snapshot view may further show the percent improvement in the most recent diagnostic test the student has taken. The snapshot view may further include a message board to receive messages from advisors, teachers, support persons, or peers.

b. Study Plan View

The Study Plan view shows the student which items the student need to study. Preferably the Study Plan shows the student which items are most important to study in order to maximize the efficiency of the student's study time. The Study Plan may be a listing the topics to be studied and the sequence the student should use to plan their study schedule.

The Study Plan may be organized based on the analysis of the tests provided by the Testing Entity, on the student's performance on a diagnostic test, on the student's goals, or any combination of those factors. Preferably, the order of the Study Plan is based on the student's results on diagnostic tests, the student's goals, and information obtained from an analysis of actual tests.

The analysis has been done based on actual tests from the Testing Entity, based on descriptive literature from the Testing Entity, or some combination to determine the weightings of the various content/skills tested by the Testing Entity. In this manner, the student may avoid focusing on content that is infrequently tested by the Testing Entity.

The percent correct/incorrect has been determined for each of these content/skills on a diagnostic test taken by the student (e.g., the DSMT Pre-Test). This analysis will allow the student to avoid focusing on content which they have already mastered.

Based on the above described analysis, an algorithm is used to determine which content/skills, if mastered, will have the greatest effect on the scaled score of the student on the actual standardized test. The items are listed in the order of importance of effect on the scaled score of the test (the bottom line). This means for the student, to have the greatest impact on their score on the real test, he/she should master item 1, then item 2, then item 3, etc. This is the sequence the student should use to plan their schedule. Thus, the sequence of study is a determination of the subjects that will have the greatest effect on the bottom line score (usually the scaled score) for the student on the actual standardized test and is not simply the percent correct or incorrect.

c. Scheduler View

The scheduler view is a tool that allows the student to set their study schedule. The scheduler view may include a monthly calendar and a list of content to be studied. Preferably, the list of content will be listed per the order in the Study Plan. In the preferred embodiment the student may drag, determine the number of items, and drop to the day they desire. The student may then enter the amount to time they wish to schedule for studying that particular topic. It will include all of the Topics, Modules, and Concepts, the various diagnostic tests, options for other items to be scheduled (such as internet review time, meeting with tutors, counselors or class time). To gain the most benefit from the system, the schedule the student sets up should be tied to the results of the Study Plan. The schedule will then be stored in the system database in order to be accessible from other screen for review and processing.

iii. Menu

The menu tool takes the student from the screen that they are in to the menu of that section. From the menu of each section the student may go to the main menu.

iv. Test Reports

The Test Report Tool allows the student to view the results of all of the diagnostic tests taken by the student. Preferably the tests are listed sequentially by the date taken for comparison. The Test Report Tool may include an Assessment Test view, a Practice Test view, and/or a Content Review Test view. The Test Report Tool may further include an Interactive Test view, a Concealed Skills Test View, and/or a Mock Test view. As stated previously, the button for the Test Report Tool is preferably available on the menu bar on all screens.

Within any of the types of test views described above, there is preferably the option to “View All” or to “Compare Tests.” The “View All” option shows all the tests sequentially. The “Compare Tests” option allows the student to click any two tests (at the box at top of test column) and then compare the change in score.

a. Assessment Test View

The Test Report Tool preferably includes an Assessment Test view. The student may preferably choose to view their scores by section, by subject, or by topic within the Assessment Test View. For the MCAT, the Assessment Test view preferably shows the percent correct and also an estimated scaled score for the both the subtests and overall test. The tests are preferably listed sequentially by date for comparisons. As stated above, there is preferably an option to “View All” or to “Compare Tests.” Further, the test results are preferably listed for each of the computer based test taking options: “Normal,” “Timed,” and “Booster.”

b. Practice Test View

The Test Report Tool preferably includes a Practice Test view. The Practice Tests are preferably the actual Practice Tests from the Testing Entity. As discussed previously, for the MCAT the official practice test, the AMPT, is only offered by the AAMC. However, the student may enter their answers into the system, and the system will analyze the student's answers.

Within the Practice Test view the student may view their scores by Section. For example, for the MCAT, the Practice Test view may include a tab for Verbal Reasoning, a tab for Biological Sciences, and a tab for Physical Sciences. Within each Section view, the test report shows percent correct for the specific test taking skills identified and for each of particular Subjects included in that Section. The Practice Test view may further display an estimated scaled score. The student may further click on and of the Subjects to view a list of the Topics within that Subject and a percent correct for each Topic. The student may further click on the Topic to view the Modules within that Topic and the percent correct for each Module.

The scores of the Practice Tests are preferably given based on a percent correct and also an estimated scale score. The Practice Tests are preferably listed sequentially by date for comparisons. As stated above, there is preferable an option to “View All” or to “Compare Tests.”

c. Review Test View

The Test Report Tool preferably includes a Review Test view. Within the Review Test view the system preferably displays the number of questions in the test. The Review Test view preferably allows the student to view each subject area down to the Concept level. The subject areas for the MCAT Review Tests preferably include Math, Physics, General Chemistry, Organic Chemistry, Biology, Test Taking Skills, and Verbal Reasoning. For the MCAT, the Review Test view preferably shows the percent correct and also an estimated scaled score. A percent correct may be given down to the Concept level of the hierarchy. The tests are preferably listed sequentially by date for comparisons. As stated above, there is preferable an option to “View All” or to “Compare Tests.” Further, the test results are preferable listed for each of the computer based test taking options: “Normal,” “Timed,” and “Booster.” It is contemplated that the Review Test view could include all of the Review Tests, for example the Content Review Test, the Interactive Test, and the Concealed Skills Test. Alternatively each type of Review Test could have its own view. If each type of Review Test has its view, the Review Test view would show the results of the Content Review Tests.

The Test Report Tool may also include an Interactive Test view. Within the Interactive Test view the system preferably displays the number of questions in the test. The Interactive Test view preferably allows the student to view each subject area down to the Concept level. The subject areas for the MCAT Interactive Test preferably include Math, Physics, General Chemistry, Organic Chemistry, Biology, Test Taking Skills, and Verbal Reasoning. For the MCAT, the Interactive Test view preferably shows the percent correct and also an estimated scaled score. A percent correct is given down to the Concept of the hierarchy. The tests are preferably listed sequentially by date for comparisons. As stated above, there is preferable an option to “View All” or to “Compare Tests.” Further, the test results are preferable listed for each of the computer based test taking options: “Normal,” “Timed,” and “Booster.” However it is also contemplated that the Interactive Test results could be shown in the Review Test view.

The Test Report Tool may also include a Concealed Skills Test view. Within the Concealed Skills Test view the system preferably displays the number of questions in the test. The Concealed Skills Test view preferably allows the student to view each subject area down to the Concept level. The subject areas for the MCAT Concealed Skills Test preferably include Math, Physics, General Chemistry, Organic Chemistry, Biology, Test Taking Skills, and Verbal Reasoning. For the MCAT, the Concealed Skills Test view preferably shows the percent correct and also an estimated scaled score. A percent correct is given down to the Concept of the hierarchy. The tests are preferably listed sequentially by date for comparisons. As stated above, there is preferable an option to “View All” or to “Compare Tests.” Further, the test results are preferable listed for each of the computer based test taking options: “Normal,” “Timed,” and “Booster.” However, it is also contemplated that the Concealed Skills results could be shown in the Review Test view.

f. Mock Test View

The Test Report Tool may also include a Mock Test view. Within the Mock Test view the system preferably displays the number of questions in the test. The Mock Test view preferably allows the student to view each subject area down to the Concept level. The subject areas for the MCAT review tests preferably include Math, Physics, General Chemistry, Organic Chemistry, Biology, Test Taking Skills, and Verbal Reasoning. For the MCAT, the Mock Test view preferably shows the percent correct and also an estimated scaled score. A percent correct is given down to the Module level of the hierarchy. The tests are preferably listed sequentially by date for comparisons. As stated above, there is preferable an option to “View All” or to “Compare Tests.” Further, the test results are preferable listed for each of the computer based test taking options: “Normal,” “Timed,” and “Booster.” However, it is also contemplated that the Mock Test results could be viewed under the Assessment Test view.

v. Profile

The Profile Tool is preferably present on the menu bar on all screens. The Profile Tool contains all the demographic information on the student. For example, the demographic information may include the student's name, address, username, and password. The Profile Tool may also allow the student to change their password. The Profile Tool may further inform the student of the subscription start and end dates. The Profile Tool may allow the student to set their goals for the test, as well as any subsections of the test. For the MCAT, this will be the scores on each of the subtests. This goal is then used to set the performance levels expected for the student. The student may update their profile information at any time during the study process.

vi. Search

The search tool allows the student to search for more information on a Concept. For example, if the student needs more information on. The search tool has a Concepts screen, a flashcard screen, and an equations screen.

III. Study Method

A. General Method

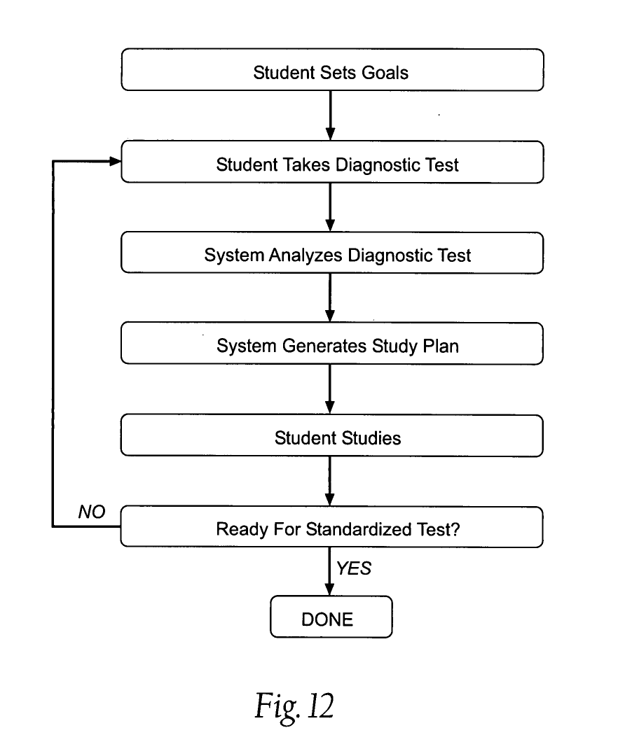

The general method of using the system is shown in FIG. 12. The student first sets their test goals. The student then takes a diagnostic test. Preferably the diagnostic test is based on an analysis of the actual test the student is preparing for. In this manner, the diagnostic test will be a more accurate representation of the student's potential performance. The diagnostic test may be a static pre-made test or may be a dynamic test generated by the system from the Question Pool. The system then generates a test report on the student's performance on the diagnostic test.

The system then generates a Study Plan. The Study Plan may be based on the analysis of the actual test, the student's performance on the diagnostic test, the student's goals, or any combination thereof. In order to most optimize the student's study time, the Study Plan would be based on all three aspects. The analysis of the test will identify the Concepts or aspects of the test which are most likely to come up. The student's performance on the diagnostic test will identify the Concepts that the student has already mastered and does not need to study as well as the student's weaknesses. The student's goals will identify how much of the material needs to be mastered. For example, if a student has a very high goal score, the student will need to master most, if not all, of the Concepts. However, if the student has a relatively low goal score, the student will need to master fewer of the Concepts. The Study Plan preferably lists the Concepts in order of importance to the student. In other words, the Concept that will be of the most importance in improving the student's score will be listed first.

The student may then prepare a personalized study schedule, if desired, based on the Study Plan. The study may then use the resources of the Study Center based on the study schedule and Study Plan. When the student feels they have completed their studies in a particular Module, they may take a review test for that Module. If the student is not pleased with their score on the review test, they may continue to utilize the study resources until they have mastered the desired material.

The student may then repeat the cycle as many times as is desired.

It is also contemplated that the student may go through the cycle multiple times, taking different types of diagnostic tests as they progress through the cycles. For example, the first time through the cycle, the student may take an Assessment Test, or a Pre-Test as their diagnostic test. The second time through the cycle the student may take an Assessment Test, or a Post-Test as their diagnostic test. The student may continue to repeat the cycle using Post-Tests until they feel they have mastered most of the material. The student may then repeat the cycle taking a Practice Test as their diagnostic test. The student may continue repeating the cycle until they have taken all of the Practice Tests available, or until the student is prepared to take the actual test.

B. Application to MCAT

The preferred embodiment is an online interactive system for test preparation. The online interactive test preparation system preferably uses computers (whether desktop, lap top or otherwise portable or mobile such as cellular phones or equivalents), monitors/interfaces, operating systems (such as Windows or Linux or others), internet capability with wire based or wireless connections, software such as produced by Microsoft and other providers, remote server with adequate storage capacity/processing capacity/security capacity, text messaging, email and portable sending and receiving devices, and commercial systems for on-line live interactive conferencing such as Glance, and others. The student may purchase a subscription and acquire a user name and password to log-in to the system.

i. First Cycle

Once the student is set up access to the system, the student may log on to the system. Preferably, on the first login, the system will prompt the student to enter information into the Profile Tool. As described above, the student preferably enters their test goals into the Profile Tool. These test goals include what score the student would like to obtain in each section of the test. For the MCAT, the student should enter what score they would like to obtain on the Physical Science section, the Biological Science section, and the Verbal Reasoning section. The platform may then use the student's goals to determine a percentage of questions correct that the student will need to achieve to meet that goal. This percentage of questions correct is based on the analysis of the actual test and information provided by the Testing Entity.

The student may then take an Assessment Test to assess their current level of preparedness for the examination. For MCAT preparation, the Assessment Test is Pre-Test. Preferably this is a computer based test. The Pre-Test is preferably generated by the system based on the results of the analysis of the AMPT in order to provide an Assessment Test that is as close to actual test conditions as possible. The system then analyses the student's responses to the Pre-Test and generates a test report. The test report is preferably stored in the Test Report Tool.

A Study Plan is then prepared for the student. The Study Plan is preferably generated by the system. As stated previously the Study Plan may be based on the analysis of the AMPT, the analysis of the student's performance on the Pre-Test, the student's goals, or any combination thereof. Preferably, the Study Plan is based on all of those factors in order to provide the most customized Study Plan for the student. The Study Plan preferably lists, in order of importance, the topics that the student should study in order to achieve their goals. The Study Plan is preferably located in the Dashboard tool.

The student may then use the Scheduler Tool to set up a study schedule. The Scheduler Tool has been described in more detail above. The student may then use the resources in the Study Center to study for the MCAT. In order to most effectively and efficiently prepare for the exam, the student should study based on the Study Plan prepared by the system and the Schedule prepared by the student. The Study Center and its resources have been described in detail above. Within the Study Center the student will study specific content areas. Once a student has completed their study of a specific content area, the student may take a Review Test to determine their mastery of the content. The Review Test is described above in detail.

At any time during the study process the student may use the search, flag, or comment tools to augment their studies and plan for future studies. The student may also use the resources in the Support Center such as “Ask the Expert.” The student may further use the Dashboard Tool to get feedback, to see how other students are doing, to review their Study Plan, or to update their schedule.

ii. Second Cycle

The student may then take a second Assessment Test to re-assess their level of preparedness for the examination. For MCAT preparation, the second Assessment Test is Post-Test. The Post-Test has been described in further detail above. Preferably this is a computer based test. As stated above in reference to the Pre-Test, the Post-Test is preferably generated by the system based on the results of the analysis of the AMPT in order to provide an Assessment Test that is as close to actual test conditions as possible. The system then analyses the student's responses to the Post-Test and generates a test report. The test report is created as described above. The test report is preferably stored in the Test Report Tool.

A revised Study Plan is then prepared for the student. The revised Study Plan is preferably generated based on the student's results on the Post-Test and the Goals set by the student. The Study Plan is created in the same manner as is described above. As discussed above, the Study Plan preferably lists, in order of importance, the topics that the student should study in order to achieve their goals. The Study Plan is preferably located in the Dashboard tool.

The student may then use the Scheduler Tool to revise their study schedule. The Scheduler Tool has been described in more detail above. The student may then use the resources in the Study Center to continue study for the MCAT. In order to most effectively and efficiently prepare for the exam, the student should study based on the most recent Study Plan prepared by the system and the revised Schedule prepared by the student. The Study Center and its resources have been described in detail above. Within the Study Center the student will study specific content areas. Once a student has completed their study of a specific content area, the student may take a Review Test to determine their mastery of the content. The Review Test is described above in detail.

As described above, the student may use the resources of the Support Center, the Study Center, and the Menu Bar at any time during their study process. For example, the student may use the search, flag, or comment tools to augment their studies and plan for future studies. The student may also use the resources in the Support Center such as “Ask the Expert.” The student may further use the Dashboard Tool to get feedback and see how other students are doing.

The steps of the second cycle may be repeated until the student has mastered all of most of the Concepts identified by the Assessment Tests. It should be noted that multiple Post-Test Assessment Tests may be generated by the system, as described in more detail above.

iii. Third Cycle

The student may then begin to take practice tests. As discussed above, for the MCAT the AMPT is the gold standard. However, at this time, this test is only administered by the AAMC. Therefore the student should take the first AMPT 3R (AAMC 3CBT) test either on paper on the AAMC website. The student's answers can then be entered into the system through the Test Center in order to analyze the student's progress and prepare a Study Plan. If at some point, AAMC or another Testing Entity allowed it, the questions themselves could be entered into system database for display and use by the students. This would make the preparation even more efficient. The system then generates a test report which is preferably stored in the Test Report Tool. The test report is created as described above.

A revised Study Plan is then prepared for the student. The revised Study Plan is preferably generated based on the student's results on the practice test and the Goals set by the student. The Study Plan is created in the same manner as is described above. As discussed above, the Study Plan preferably lists, in order of importance, the topics that the student should study in order to achieve their goals. The Study Plan is preferably located in the Dashboard tool.

The student may then use the Scheduler Tool to revise their study schedule. The Scheduler Tool has been described in more detail above. The student may then use the resources in the Study Center to continue study for the MCAT. In order to most effectively and efficiently prepare for the exam, the student should study based on the most recent Study Plan prepared by the system and the revised Schedule prepared by the student. The Study Center and its resources have been described in detail above. Within the Study Center the student will study specific content areas. Once a student has completed their study of a specific content area, the student may take a Review Test to determine their mastery of the content. The Review Test is described above in detail. The student may also take Mock Tests in the Study Center.

At this point the student should also include MCAT solutions, test taking skills, and ancillary reading materials to their studying. As described above, the student may use the resources of the Support Center, the Study Center, and the Menu Bar at any time during their study process. For example, the student may use the search, flag, or comment tools to augment their studies and plan for future studies. The student may also use the resources in the Support Center such as “Ask the Expert.” The student may further use the Dashboard Tool to get feedback and see how other students are doing.

The cycle could then be repeated for each additional AMPT.

It is contemplated that with each cycle the student's knowledge and skills will improve with each cycle.

Although the preferred study program and diagnostic testing order has been described above, it should be understood that this order may be altered and does not deviate from the invention. For example, the student may decide not to take review tests. Further, the student may take practice tests at any time. The student may choose to utilize any combination of the study resources in any order, or not use the study resources.

Although the preferred embodiment provides for a system that is used over the internet, an alternate embodiment may provide the system and database on a disc that can be installed on a student's computer. In such an embodiment, the Test Center and Study Center could then be on the disc, while the Support Center could be online.

The preferred embodiment of the information hierarchy for the MCAT is Section-Subject-Topic-Module-Concept hierarchy. For the MCAT there are preferably four sections which correspond to the subtests of the MCAT: Physical Sciences, Biological Sciences, Verbal Reasoning, and Writing. The information hierarchy including Subject, Topic, Module, and Concept for the Physical Sciences and Biological Sciences are shown and described in Table 1 below.

In a preferred embodiment the Subjects within the Physical Sciences Section include Physics, General Chemistry, and Math. In the preferred embodiment the Subjects within the Biological Sciences Section include Biology and Organic Chemistry.

It is contemplated that

TABLE 1

| Subject | Topics | Modules | Concepts |
|---|---|---|---|
| Physics | Electromagnetism | Electrostatics | Coulomb's Law |
| Physics | Electromagnetism | Electrostatics | Electric Field |
| Physics | Electromagnetism | Electrostatics | Electric |
| | | | Potential- |
| | | | General |
| | | | Overview |
| Physics | Electromagnetism | Electrostatics | Electric |
| | | | Potential-Lines |
| | | | & Surfaces |
| Physics | Electromagnetism | Electric | General |
| | | Circuits | Overview |
| Physics | Electromagnetism | Electric | Current |
| | | Circuits | |
| Physics | Electromagnetism | Electric | Electric |
| | | Circuits | Potential-emf & |
| | | | current |
| Physics | Electromagnetism | Electric | Resistors in |
| | | Circuits | Circuits |
| Physics | Electromagnetism | Electric | Capacitance- |
| | | Circuits | General |
| | | | Overview |
| Physics | Electromagnetism | Electric | Capacitors in |
| | | Circuits | Electric |
| | | | Circuits |
| Physics | Electromagnetism | Electric | Power- |
| | | Circuits | Electrical |
| Physics | Electromagnetism | Magnetism | General |
| | | | Overview |
| Physics | Electromagnetism | Magnetism | Magnetic flux & |
| | | | Ampere's Law |
| Physics | Electromagnetism | Magnetism | Toroids & |
| | | | solenoids |
| Physics | Electromagnetism | Magnetism | Magnetic Field |
| | | | Direction-Right |
| | | | H& Rule |
| Physics | Electromagnetism | Magnetism | Magnetism, |
| | | | effect on |
| | | | charges |
| Physics | Electromagnetism | Electromagnetic | General |
| | | Waves | overview |
| Physics | Electromagnetism | Electromagnetic | Electromagnetic |
| | | Waves | wave types |
| Physics | Electromagnetism | Electromagnetic | Polarization |
| | | Waves | |
| Physics | Electromagnetism | Electromagnetic | Interactions |
| | | Waves | with matter |
| Physics | Kinematics | Kinematics | General |
| | & Dynamics | (motion) | Overview |
| Physics | Kinematics | Kinematics | Uniform |
| | & Dynamics | (motion) | Accelerated |
| | | | Motion |
| Physics | Kinematics | Kinematics | Free Fall |
| | & Dynamics | (motion) | Motion |
| Physics | Kinematics | Kinematics | Projectile |
| | & Dynamics | (motion) | motion |
| Physics | Kinematics | Kinematics | Circular motion |
| | & Dynamics | (motion) | |
| Physics | Kinematics | Kinematics | Rotational |
| | & Dynamics | (motion) | motion |
| Physics | Kinematics | Kinematics | Simple harmonic |
| | & Dynamics | (motion) | motion-general |
| | | | overview |
| Physics | Kinematics | Kinematics | Simple harmonic |
| | & Dynamics | (motion) | motion-pendulum |
| Physics | Kinematics | Forces | General |
| | & Dynamics | | overview of |
| | | | forces |
| Physics | Kinematics | Forces | Newton's Law of |
| | & Dynamics | | Motion |
| Physics | Kinematics | Forces | Hooke's Law |
| | & Dynamics | | |
| Physics | Kinematics | Forces | Friction |
| | & Dynamics | | |
| Physics | Kinematics | Forces | Gravity |
| | & Dynamics | | |
| Physics | Kinematics | Forces | Forces on an |
| | & Dynamics | | Object-General |
| | | | Overview |
| Physics | Kinematics | Forces | Forces on |
| | & Dynamics | | objects on flat |
| | | | surfaces |
| Physics | Kinematics | Forces | Forces on |
| | & Dynamics | | objects on |
| | | | inclined planes |
| Physics | Kinematics | Forces | Forces on |
| | & Dynamics | | objects on |
| | | | strings |
| Physics | Kinematics | Forces | Static |
| | & Dynamics | | equilibrium |
| Physics | Kinematics | Energy & Work | Kinetic energy |
| | & Dynamics | | |
| Physics | Kinematics | Energy & Work | Potential |
| | & Dynamics | | energy |
| Physics | Kinematics | Energy & Work | Work & power |
| | & Dynamics | | |
| Physics | Kinematics | Energy & Work | Conservation of |
| | & Dynamics | | energy laws |
| Physics | Kinematics | Momentum | Center of mass |
| | & Dynamics | | |
| Physics | Kinematics | Momentum | Linear momentum |
| | & Dynamics | | |
| Physics | Kinematics | Momentum | Conservation of |
| | & Dynamics | | linear momentum |
| Physics | Physics | Fluid Physics | Fluid pressure |
| | Fluids & | | |
| | Solids | | |
| Physics | Physics | Fluid Physics | Buoyancy |
| | Fluids & | | |
| | Solids | | |
| Physics | Physics | Fluid Physics | Fluid flow- |
| | Fluids & | | general |
| | Solids | | overview |
| Physics | Physics | Fluid Physics | Fluid flow- |
| | Fluids & | | Bernoulli's |
| | Solids | | Equation |
| Physics | Physics | Fluid Physics | Fluid flow- |
| | Fluids & | | Continuity |
| | Solids | | Equation |
| Physics | Physics | Heat Transfer | General |
| | Fluids & | | overview |
| | Solids | | |
| Physics | Physics | Heat Transfer | Conduction |
| | Fluids & | | |
| | Solids | | |
| Physics | Physics | Heat Transfer | Convection |
| | Fluids & | | |
| | Solids | | |
| Physics | Physics | Heat Transfer | Radiation of |
| | Fluids & | | heat |
| | Solids | | |
| Physics | Physics | Heat Transfer | Effect of |
| | Fluids & | | temperature on |
| | Solids | | object size |
| Physics | Physics | Stress & Strain | Tensile stress |
| | Fluids & | | & strain |
| | Solids | | |
| Physics | Physics | Stress & Strain | Shear stress & |
| | Fluids & | | strain |
| | Solids | | |
| Physics | Physics | Stress & Strain | Bulk stress & |
| | Fluids & | | Strain |
| | Solids | | |
| Physics | Waves, | Waves, General | General wave |
| | Sound, & | | characteristics |
| | Light | | |
| Physics | Waves, | Waves, General | Wave energy |
| | Sound, & | | relationships |
| | Light | | |
| Physics | Waves, | Waves, General | Wave intensity |
| | Sound, & | | |
| | Light | | |
| Physics | Waves, | Waves, General | Coherency & |
| | Sound, & | | chromaticity |
| | Light | | |
| Physics | Waves, | Waves, General | Phase angle |
| | Sound, & | | |
| | Light | | |
| Physics | Waves, | Waves, General | Wave velocity |
| | Sound, & | | in a medium |
| | Light | | |
| Physics | Waves, | Waves, General | Wave equation |
| | Sound, & | | (relationship) |
| | Light | | |
| Physics | Waves, | Sound | Sound |
| | Sound, & | | |
| | Light | | |
| Physics | Waves, | Doppler | Doppler |
| | Sound, & | | |
| | Light | | |
| Physics | Waves, | Reflection & | Reflection |
| | Sound, & | Mirrors | |
| | Light | | |
| Physics | Waves, | Reflection & | Mirrors-plane |
| | Sound, & | Mirrors | |
| | Light | | |
| Physics | Waves, | Reflection & | Mirrors-curved |
| | Sound, & | Mirrors | |
| | Light | | |
| Physics | Waves, | Refraction & | Refraction |
| | Sound, & | Lenses | |
| | Light | | |
| Physics | Waves, | Refraction & | Complete |
| | Sound, & | Lenses | internal |
| | Light | | reflection & |
| | | | apparent depth |
| Physics | Waves, | Refraction & | Lenses-general |
| | Sound, & | Lenses | overview |
| | Light | | |
| Physics | Waves, | Refraction & | Converging lens |
| | Sound, & | Lenses | image formation |
| | Light | | |
| Physics | Waves, | Refraction & | Diverging lens |
| | Sound, & | Lenses | image formation |
| | Light | | |
| Physics | Waves, | Refraction & | Lens equation |
| | Sound, & | Lenses | |
| | Light | | |
| Physics | Waves, | Refraction & | Dioptres |
| | Sound, & | Lenses | |
| | Light | | |
| Physics | Waves, | Waves- | General |
| | Sound, & | interactions | overview |
| | Light | | |
| Physics | Waves, | Waves- | Interference |
| | Sound, & | interactions | general |
| | Light | | overview |
| Physics | Waves, | Waves- | Constructive |
| | Sound, & | interactions | interference |
| | Light | | |
| Physics | Waves, | Waves- | Destructive |
| | Sound, & | interactions | interference |
| | Light | | |
| Physics | Waves, | Waves- | Beats |
| | Sound, & | interactions | |
| | Light | | |
| Physics | Waves, | Waves- | Interference- |
| | Sound, & | interactions | thin films |
| | Light | | |
| Physics | Waves, | Waves- | Interference- |
| | Sound, & | interactions | two slits |
| | Light | | |
| Physics | Waves, | Waves- | Diffraction- |
| | Sound, & | interactions | general |
| | Light | | |
| Physics | Waves, | Waves- | Diffraction- |
| | Sound, & | interactions | single slit |
| | Light | | |
| Physics | Waves, | Waves- | Diffraction |
| | Sound, & | interactions | gratings |
| | Light | | |
| Physics | Waves, | Standing Waves | Standing Waves |
| | Sound, & | | |
| | Light | | |
| Physics | Waves, | Waves-optical | Human eye |
| | Sound, & | instruments | |
| | Light | | |
| Physics | Waves, | Waves-optical | Simple |
| | Sound, & | instruments | magnifier |
| | Light | | |
| Physics | Waves, | Waves-optical | Simple Camera |
| | Sound, & | instruments | |
| | Light | | |
| Physics | Waves, | Waves-optical | Compound |
| | Sound, & | instruments | microscope |
| | Light | | |
| Physics | Waves, | Waves-optical | Telescope |
| | Sound, & | instruments | |
| | Light | | |
| Physics | Waves, | Resonance in | Resonance in |
| | Sound, & | physics | physics |
| | Light | | |
| General | Acids & | Acids & Bases | General |
| Chemistry | Bases | | Overview |
| General | Acids & | Acids & Bases | Bronsted-Lowry |
| Chemistry | Bases | | Acids & Bases |
| General | Acids & | Acids & Bases | Conjugate Acids |
| Chemistry | Bases | | & Bases |
| General | Acids & | Acids & Bases | Lewis Acids & |
| Chemistry | Bases | | Bases |
| General | Acids & | Acids & Bases | Strengths of |
| Chemistry | Bases | | Acids & Bases- |
| | | | General |
| | | | Discussion |
| General | Acids & | Acids & Bases | Strengths of |
| Chemistry | Bases | | Acids |
| General | Acids & | Acids & Bases | Strengths of |
| Chemistry | Bases | | Bases |
| General | Acids & | Acids & Bases | Salts of Acids |
| Chemistry | Bases | | & Bases |
| General | Acids & | Acids & Bases | Buffers |
| Chemistry | Bases | | |
| General | Acids & | Acids & bases-p | General |
| Chemistry | Bases | function | overview |
| General | Acids & | Acids & bases-p | pKₐ & pK_{b} |
| Chemistry | Bases | function | |
| General | Acids & | Acids & bases-p | Ion product of |
| Chemistry | Bases | function | water |
| General | Acids & | Acids & bases- | Titration |
| Chemistry | Bases | titrations | curves |
| General | Acids & | Acids & bases- | Regions of |
| Chemistry | Bases | titrations | titration |
| | | | curves |
| General | Acids & | Acids & bases- | Indicators |
| Chemistry | Bases | titrations | |
| General | Atomic, | Atomic | General |
| Chemistry | Nuclear & | Structure | overview of |
| | Molecular | | atomic |
| | Structure | | structure |
| General | Atomic, | Atomic | Bohr atom |
| Chemistry | Nuclear & | Structure | |
| | Molecular | | |
| | Structure | | |
| General | Atomic, | Atomic | Quantum atom |
| Chemistry | Nuclear & | Structure | |
| | Molecular | | |
| | Structure | | |
| General | Atomic, | Atomic | Atomic orbitals |
| Chemistry | Nuclear & | Structure | |
| | Molecular | | |
| | Structure | | |
| General | Atomic, | Atomic | Electron |
| Chemistry | Nuclear & | Structure | configuration |
| | Molecular | | |
| | Structure | | |
| General | Atomic, | Electronic | Electronic |
| Chemistry | Nuclear & | transitions | transitions |
| | Molecular | | |
| | Structure | | |
| General | Atomic, | Electronic | Atomic spectra |
| Chemistry | Nuclear & | transitions | |
| | Molecular | | |
| | Structure | | |
| General | Atomic, | Hybrid orbitals | General |
| Chemistry | Nuclear & | | overview |
| | Molecular | | |
| | Structure | | |
| General | Atomic, | Hybrid orbitals | Common hybrid |
| Chemistry | Nuclear & | | orbitals |
| | Molecular | | |
| | Structure | | |
| General | Atomic, | Hybrid orbitals | Molecular |
| Chemistry | Nuclear & | | geometry |
| | Molecular | | |
| | Structure | | |
| General | Atomic, | Periodic table | General |
| Chemistry | Nuclear & | & trends | overview of |
| | Molecular | | periodic table |
| | Structure | | |
| General | Atomic, | Periodic table | Valence |
| Chemistry | Nuclear & | & trends | electrons |
| | Molecular | | |
| | Structure | | |
| General | Atomic, | Periodic table | General |
| Chemistry | Nuclear & | & trends | overview of |
| | Molecular | | periodic trends |
| | Structure | | |
| General | Atomic, | Periodic table | Ionization |
| Chemistry | Nuclear & | & trends | energy |
| | Molecular | | |
| | Structure | | |
| General | Atomic, | Periodic table | Electron |
| Chemistry | Nuclear & | & trends | affinity |
| | Molecular | | |
| | Structure | | |
| General | Atomic, | Periodic table | Electronegativity |
| Chemistry | Nuclear & | & trends | |
| | Molecular | | |
| | Structure | | |
| General | Atomic, | Periodic table | Atomic radius |
| Chemistry | Nuclear & | & trends | |
| | Molecular | | |
| | Structure | | |
| General | Atomic, | Chemical | General |
| Chemistry | Nuclear & | structures & | overview |
| | Molecular | bonding | |
| | Structure | | |
| General | Atomic, | Chemical | Lewis dot |
| Chemistry | Nuclear & | structures & | structures |
| | Molecular | bonding | |
| | Structure | | |
| General | Atomic, | Chemical | Common |
| Chemistry | Nuclear & | structures & | molecules & |
| | Molecular | bonding | ions |
| | Structure | | |
| General | Atomic, | Stoichiometry | Chemical |
| Chemistry | Nuclear & | | equations |
| | Molecular | | |
| | Structure | | |
| General | Atomic, | Stoichiometry | Moles |
| Chemistry | Nuclear & | | |
| | Molecular | | |
| | Structure | | |
| General | Atomic, | Stoichiometry | Empirical |
| Chemistry | Nuclear & | | formulas |
| | Molecular | | |
| | Structure | | |
| General | Atomic, | Stoichiometry | Limiting |
| Chemistry | Nuclear & | | reagents |
| | Molecular | | |
| | Structure | | |
| General | Atomic, | Stoichiometry | Reaction types |
| Chemistry | Nuclear & | | |
| | Molecular | | |
| | Structure | | |
| General | Atomic, | Bonding | General |
| Chemistry | Nuclear & | | overview |
| | Molecular | | |
| | Structure | | |
| General | Atomic, | Bonding | Covalent bonds |
| Chemistry | Nuclear & | | |
| | Molecular | | |
| | Structure | | |
| General | Atomic, | Bonding | Ionic bonds |
| Chemistry | Nuclear & | | |
| | Molecular | | |
| | Structure | | |
| General | Atomic, | Bonding | Octet rule |
| Chemistry | Nuclear & | | |
| | Molecular | | |
| | Structure | | |
| General | Atomic, | Bonding | Bond breaking |
| Chemistry | Nuclear & | | mechanisms |
| | Molecular | | |
| | Structure | | |
| General | Atomic, | Bonding | Polarity of |
| Chemistry | Nuclear & | | molecules |
| | Molecular | | |
| | Structure | | |
| General | Atomic, | Bonding | Dipole moments |
| Chemistry | Nuclear & | | |
| | Molecular | | |
| | Structure | | |
| General | Atomic, | Bonding | Electron |
| Chemistry | Nuclear & | | withdrawing |
| | Molecular | | groups |
| | Structure | | |
| General | Atomic, | Intermolecular | Intermolecular |
| Chemistry | Nuclear & | forces | forces |
| | Molecular | | |
| | Structure | | |
| General | Atomic, | Nuclear | Nuclear |
| Chemistry | Nuclear & | chemistry | particles |
| | Molecular | | |
| | Structure | | |
| General | Atomic, | Nuclear | Nuclear |
| Chemistry | Nuclear & | chemistry | reactions |
| | Molecular | | |
| | Structure | | |
| General | Atomic, | Nuclear | Nuclear |
| Chemistry | Nuclear & | chemistry | radioactive |
| | Molecular | | decay |
| | Structure | | |
| General | Atomic, | Nuclear | Radioactive |
| Chemistry | Nuclear & | chemistry | dating |
| | Molecular | | |
| | Structure | | |
| General | Atomic, | Nuclear | Nuclear fission |
| Chemistry | Nuclear & | chemistry | |
| | Molecular | | |
| | Structure | | |
| General | Atomic, | Nuclear | Nuclear fusion |
| Chemistry | Nuclear & | chemistry | |
| | Molecular | | |
| | Structure | | |
| General | Electrochemistry | Electrochemistry | General |
| Chemistry | | | overview |
| General | Electrochemistry | Electrochemistry | Formal charge |
| Chemistry | | | |
| General | Electrochemistry | Electrochemistry | Oxidation state |
| Chemistry | | | |
| General | Electrochemistry | Electrochemistry | Reduction |
| Chemistry | | | potention |
| General | Electrochemistry | Electrochemistry | Concentration |
| Chemistry | | | cells |
| General | Electrochemistry | Electrochemistry | Electrolytic |
| Chemistry | | | cells |
| General | Electrochemistry | Electrochemistry | Galvanic cells |
| Chemistry | | | |
| General | Electrochemistry | Electrochemistry | Disproportionation |
| Chemistry | | | |
| General | Electrochemistry | Electrochemistry | Redox titration |
| Chemistry | | | |
| General | Gases, | Concentration | Concentration |
| Chemistry | Fluids & | units | units |
| | Solids | | |
| General | Gases, | Density, | Density & |
| Chemistry | Fluids & | viscosity, & | specific |
| | Solids | surface tension | gravity |
| General | Gases, | Density, | Viscosity |
| Chemistry | Fluids & | viscosity, & | |
| | Solids | surface tension | |
| General | Gases, | Density, | Surface tension |
| Chemistry | Fluids & | viscosity, & | |
| | Solids | surface tension | |
| General | Gases, | Gases | Ideal gases |
| Chemistry | Fluids & | | |
| | Solids | | |
| General | Gases, | Gases | Pressures of |
| Chemistry | Fluids & | | gases |
| | Solids | | |
| General | Gases, | Gases | Real gases |
| Chemistry | Fluids & | | |
| | Solids | | |
| General | Gases, | Gases | Kinetic |
| Chemistry | Fluids & | | molecular |
| | Solids | | theory |
| General | Gases, | Gases | Dalton's Law of |
| Chemistry | Fluids & | | Partial |
| | Solids | | Pressures |
| General | Gases, | Solids | Solids |
| Chemistry | Fluids & | | |
| | Solids | | |
| General | Gases, | Solubility | General |
| Chemistry | Fluids & | | overview |
| | Solids | | |
| General | Gases, | Solubility | Solubility |
| Chemistry | Fluids & | | product |
| | Solids | | |
| General | Gases, | Solubility | Solubility |
| Chemistry | Fluids & | | rules |
| | Solids | | |
| General | Gases, | Solubility | Solubility |
| Chemistry | Fluids & | | factors |
| | Solids | | |
| General | Gases, | Colligative | Types |
| Chemistry | Fluids & | properties | |
| | Solids | | |
| General | Gases, | Colligative | Electrolytes & |
| Chemistry | Fluids & | properties | non- |
| | Solids | | electrolytes |
| General | Gases, | Colligative | Vapor pressure |
| Chemistry | Fluids & | properties | |
| | Solids | | |
| General | Gases, | Colligative | Boiling points |
| Chemistry | Fluids & | properties | |
| | Solids | | |
| General | Gases, | Colligative | Freezing points |
| Chemistry | Fluids & | properties | |
| | Solids | | |
| General | Gases, | Colligative | Osmotic |
| Chemistry | Fluids & | properties | pressure |
| | Solids | | |
| General | Gases, | Phase diagrams | Phase |
| Chemistry | Fluids & | | interconversions |
| | Solids | | |
| General | Gases, | Phase diagrams | Phase |
| Chemistry | Fluids & | | diagrams/graphs |
| | Solids | | |
| General | Gases, | Phase diagrams | Phase |
| Chemistry | Fluids & | | relationships |
| | Solids | | of vapor |
| | | | pressure & |
| | | | boiling point |
| General | Gases, | Phase diagrams | Phase energy |
| Chemistry | Fluids & | | changes |
| | Solids | | |
| General | Thermodynamics & | Equilibria | General |
| Chemistry | Kinetics | | |
| General | Thermodynamics & | Equilibria | LeChatelier |
| Chemistry | Kinetics | | Principle |
| General | Thermodynamics & | Thermodynamics | General |
| Chemistry | Kinetics | | |
| General | Thermodynamics & | Thermodynamics | Enthalpy |
| Chemistry | Kinetics | | |
| General | Thermodynamics & | Thermodynamics | Entropy |
| Chemistry | Kinetics | | |
| General | Thermodynamics & | Thermodynamics | Free energy |
| Chemistry | Kinetics | | |
| General | Thermodynamics & | Kinetics | Rates & rate |
| Chemistry | Kinetics | | constants |
| General | Thermodynamics & | Kinetics | Order of |
| Chemistry | Kinetics | | reaction |
| General | Thermodynamics & | Kinetics | Factors |
| Chemistry | Kinetics | | affecting rates |
| General | Thermodynamics & | Kinetics | Activation |
| Chemistry | Kinetics | | energy |
| Math | General | Approximation | Approximation |
| | Math | | |
| Math | General | Equation | General |
| | Math | interpretation | overview |
| Math | General | Equation | Solving for a |
| | Math | interpretation | parameter in an |
| | | | equation |
| Math | General | Equation | To determine |
| | Math | interpretation | the effect of |
| | | | the change of a |
| | | | parameter on |
| | | | the equation or |
| | | | another |
| | | | parameter |
| Math | General | Equation | To translate |
| | Math | interpretation | the equation's |
| | | | parameters to |
| | | | graphical |
| | | | relationships |
| Math | General | Estimation of | Estimation of |
| | Math | square roots | square roots |
| Math | General | Exponentials & | Rules for |
| | Math | roots | exponentials & |
| | | | roots |
| Math | General | Exponentials & | Scientific |
| | Math | roots | notation |
| Math | General | Exponentials & | Exponential |
| | Math | roots | graphs |
| Math | General | Logarithms | General |
| | Math | | overview |
| Math | General | Logarithms | Logarithm rules |
| | Math | | |
| Math | General | Logarithms | Logarithm |
| | Math | | graphs |
| Math | General | Logarithms | Logarithm |
| | Math | | examples |
| Math | General | Percentage | Percentage |
| | Math | | |
| Math | General | Quadratic | Quadratic |
| | Math | equation | equation |
| Math | General | Ratio & | General |
| | Math | proportion | discussion |
| Math | General | Ratio & | Examples |
| | Math | proportion | |
| Math | General | Significant | Significant |
| | Math | figures | figures |
| Math | General | Simultaneous | Simultaneous |
| | Math | equations | equations |
| Math | Geometry, | Geometry | Geometric |
| | Trigonometry & | | relations |
| | Graphs | | |
| Math | Geometry, | Geometry | Perimeters, |
| | Trigonometry & | | areas & volumes |
| | Graphs | | |
| Math | Geometry, | Geometry | Radians |
| | Trigonometry & | | |
| | Graphs | | |
| Math | Geometry, | Graphs & Charts | Cartesian |
| | Trigonometry & | | coordinate |
| | Graphs | | system |
| Math | Geometry, | Graphs & Charts | Straight line |
| | Trigonometry & | | formula |
| | Graphs | | |
| Math | Geometry, | Graphs & Charts | Slopes |
| | Trigonometry & | | |
| | Graphs | | |
| Math | Geometry, | Graphs & Charts | Area under the |
| | Trigonometry & | | curve |
| | Graphs | | |
| Math | Geometry, | Graphs & Charts | Relationships |
| | Trigonometry & | | of variables |
| | Graphs | | |
| Math | Geometry, | Graphs & Charts | Inverse |
| | Trigonometry & | | relationship & |
| | Graphs | | direct square |
| | | | relationship |
| Math | Geometry, | Trigonometry | Basic trig |
| | Trigonometry & | | functions |
| | Graphs | | |
| Math | Geometry, | Trigonometry | Graphs of trig |
| | Trigonometry & | | functions |
| | Graphs | | |
| Math | Geometry, | Trigonometry | Special |
| | Trigonometry & | | triangles & |
| | Graphs | | trig functions |
| Math | Geometry, | Trigonometry | Inverse trig |
| | Trigonometry & | | functions |
| | Graphs | | |
| Math | Vectors & | First order | General |
| | Others | rates | overview |
| Math | Vectors & | First order | First order |
| | Others | rates | rates calculus |
| | | | derivation |
| Math | Vectors & | First order | First order |
| | Others | rates | rate constants |
| Math | Vectors & | First order | Half lives & |
| | Others | rates | doubling times |
| Math | Vectors & | First order | Graphs of first |
| | Others | rates | order rates |
| Math | Vectors & | Probability | Independent |
| | Others | | events |
| Math | Vectors & | Probability | Mutually |
| | Others | | exclusive |
| | | | events |
| Math | Vectors & | Probability | Conditional |
| | Others | | events |
| Math | Vectors & | Probability | Arrangement of |
| | Others | | objects |
| Math | Vectors & | Statistics | Experimental |
| | Others | | error |
| Math | Vectors & | Statistics | Statistical |
| | Others | | terminology |
| Math | Vectors & | Statistics | Distributions |
| | Others | | |
| Math | Vectors & | Statistics | Statistics |
| | Others | | examples |
| Math | Vectors & | Statistics | Statistical |
| | Others | | testing |
| Math | Vectors & | Units & | Fundamental |
| | Others | conversions | units |
| Math | Vectors & | Units & | Derived units |
| | Others | conversions | |
| Math | Vectors & | Units & | Dimensional |
| | Others | conversions | analysis |
| Math | Vectors & | Units & | Prefixes of |
| | Others | conversions | units |
| Math | Vectors & | Vectors | General |
| | Others | | overview |
| Math | Vectors & | Vectors | Vector |
| | Others | | addition-head |
| | | | to tail method |
| Math | Vectors & | Vectors | Vector |
| | Others | | addition- |
| | | | parallelogram |
| | | | method |
| Math | Vectors & | Vectors | Vector |
| | Others | | addition- |
| | | | component |
| | | | method |
| Math | Vectors & | Vectors | Vector |
| | Others | | subtraction |
| Math | Vectors & | Vectors | Vector changes |
| | Others | | |
| Organic | Alkanes, | Alkanes | General |
| Chemistry | Alkenes & | | overview |
| | Aromatics | | |
| Organic | Alkanes, | Alkanes | Halide radical |
| Chemistry | Alkenes & | | reactions |
| | Aromatics | | |
| Organic | Alkanes, | Alkanes | Combustion |
| Chemistry | Alkenes & | | reactions |
| | Aromatics | | |
| Organic | Alkanes, | Alkanes | Organometallic |
| Chemistry | Alkenes & | | compounds |
| | Aromatics | | |
| Organic | Alkanes, | Alkenes | General |
| Chemistry | Alkenes & | | overview & |
| | Aromatics | | nomenclature |
| Organic | Alkanes, | Alkenes | Electrophilic |
| Chemistry | Alkenes & | | reactions |
| | Aromatics | | |
| Organic | Alkanes, | Alkenes | Oxidation- |
| Chemistry | Alkenes & | | reduction |
| | Aromatics | | reactions |
| Organic | Alkanes, | Aromatic | General |
| Chemistry | Alkenes & | compounds | overview |
| | Aromatics | | |
| Organic | Alkanes, | Aromatic | Electrophilic |
| Chemistry | Alkenes & | compounds | substitution |
| | Aromatics | | reactions |
| Organic | Alkanes, | Electrophilic | General |
| Chemistry | Alkenes & | reactions | overview |
| | Aromatics | | |
| Organic | Alkanes, | Electrophilic | Electrophilic |
| Chemistry | Alkenes & | reactions | addition |
| | Aromatics | | reactions |
| Organic | Alkanes, | Electrophilic | Electrophilic |
| Chemistry | Alkenes & | reactions | substitution |
| | Aromatics | | reactions (see |
| | | | Aromatic) |
| Organic | Alkanes, | Elimination | Elimination |
| Chemistry | Alkenes & | reactions | reactions |
| | Aromatics | | |
| Organic | Alkanes, | Molecular | Molecular |
| Chemistry | Alkenes & | rearrangements | rearrangements |
| | Aromatics | | |
| Organic | Amines & | Amines | Nomenclature |
| Chemistry | Biologicals | | |
| Organic | Amines & | Amines | Acid & base |
| Chemistry | Biologicals | | properties |
| Organic | Amines & | Amines | Physical & |
| Chemistry | Biologicals | | chemical |
| | | | properties |
| Organic | Amines & | Amines | Reactions with |
| Chemistry | Biologicals | | alkyl halides |
| Organic | Amines & | Amines | Aromatic amines |
| Chemistry | Biologicals | | reactions with |
| | | | nitrous acid |
| Organic | Amines & | Amines | Hofman |
| Chemistry | Biologicals | | elimination |
| Organic | Amines & | Amino acids | General |
| Chemistry | Biologicals | | structure & |
| | | | properties |
| Organic | Amines & | Amino acids | Acid & base |
| Chemistry | Biologicals | | properties of |
| | | | amino Amines & |
| | | | Biologicals |
| | | | acids |
| Organic | Amines & | Amino acids | Neutral non- |
| Chemistry | Biologicals | | polar amino |
| | | | acids |
| Organic | Amines & | Amino acids | Polar amino |
| Chemistry | Biologicals | | acids |
| Organic | Amines & | Amino acids | Sulfur amino |
| Chemistry | Biologicals | | acids |
| Organic | Amines & | Amino acids | Acidic amino |
| Chemistry | Biologicals | | acids |
| Organic | Amines & | Amino acids | Basic amino |
| Chemistry | Biologicals | | acids |
| Organic | Amines & | Proteins | Proteins |
| Chemistry | Biologicals | | |
| Organic | Amines & | Carbohydrates | Straight chain |
| Chemistry | Biologicals | | forms, absolute |
| | | | configuration & |
| | | | epimers |
| Organic | Amines & | Carbohydrates | Ring forms & |
| Chemistry | Biologicals | | anomers |
| Organic | Amines & | Carbohydrates | Types of |
| Chemistry | Biologicals | | carbohydrates |
| Organic | Amines & | Lipids | Fatty acids & |
| Chemistry | Biologicals | | fats |
| Organic | Amines & | Lipids | Phospholipids |
| Chemistry | Biologicals | | |
| Organic | Amines & | Lipids | steroids |
| Chemistry | Biologicals | | |
| Organic | Laboratory | Lab | Specific |
| Chemistry | Organic | identifications | rotation |
| | Chemistry | | |
| Organic | Laboratory | Lab | Boiling points |
| Chemistry | Organic | identifications | of organic |
| | Chemistry | | compounds- |
| | | | general |
| Organic | Laboratory | Lab | Melting points |
| Chemistry | Organic | identifications | of organic |
| | Chemistry | | compounds |
| Organic | Laboratory | Lab | Spectroscoypy- |
| Chemistry | Organic | identifications | general |
| | Chemistry | | overview |
| Organic | Laboratory | Lab | Mass |
| Chemistry | Organic | identifications | spectroscopy |
| | Chemistry | | |
| Organic | Laboratory | Lab | Ultraviolet |
| Chemistry | Organic | identifications | spectroscopy |
| | Chemistry | | |
| Organic | Laboratory | Lab | Infrared |
| Chemistry | Organic | identifications | spectroscopy |
| | Chemistry | | |
| Organic | Laboratory | Lab | NMR |
| Chemistry | Organic | identifications | spectroscopy- |
| | Chemistry | | overview |
| Organic | Laboratory | Lab | NMR |
| Chemistry | Organic | identifications | spectroscopy- |
| | Chemistry | | spectrum |
| Organic | Laboratory | Lab | NMR |
| Chemistry | Organic | identifications | spectroscopy- |
| | Chemistry | | shielding, |
| | | | deshielding |
| Organic | Laboratory | Lab | NMR |
| Chemistry | Organic | identifications | spectroscopy- |
| | Chemistry | | coupling or |
| | | | spin-spin |
| | | | splitting |
| Organic | Laboratory | Lab | NMR |
| Chemistry | Organic | identifications | spectroscopy- |
| | Chemistry | | relative number |
| | | | of hydrogens |
| Organic | Laboratory | Lab | NMR |
| Chemistry | Organic | identifications | spectroscopy- |
| | Chemistry | | locations of |
| | | | H's |
| Organic | Laboratory | Lab | NMR |
| Chemistry | Organic | identifications | spectroscopy- |
| | Chemistry | | carbon 13 |
| | | | spectrum |
| Organic | Laboratory | Lab | NMR |
| Chemistry | Organic | identifications | spectroscopy- |
| | Chemistry | | summary (what |
| | | | you should |
| | | | know) |
| Organic | Laboratory | Lab separations | General |
| Chemistry | Organic | | overview |
| | Chemistry | | |
| Organic | Laboratory | Lab separations | Solubility of |
| Chemistry | Organic | | organics |
| | Chemistry | | |
| Organic | Laboratory | Lab separations | Extractions of |
| Chemistry | Organic | | organics |
| | Chemistry | | |
| Organic | Laboratory | Lab separations | Recrystallization |
| Chemistry | Organic | | |
| | Chemistry | | |
| Organic | Laboratory | Lab separations | Distillation- |
| Chemistry | Organic | | general |
| | Chemistry | | overview |
| Organic | Laboratory | Lab separations | Distillation- |
| Chemistry | Organic | | simple |
| | Chemistry | | |
| Organic | Laboratory | Lab separations | Distillation- |
| Chemistry | Organic | | fractional |
| | Chemistry | | |
| Organic | Laboratory | Lab separations | Chromatography |
| Chemistry | Organic | | |
| | Chemistry | | |
| Organic | Organic | Nomenclature | Common carbon |
| Chemistry | Structures | | straight chains |
| | & Bonding | | |
| Organic | Organic | Nomenclature | Common carbon |
| Chemistry | Structures | | branched chains |
| | & Bonding | | |
| Organic | Organic | Nomenclature | Common |
| Chemistry | Structures | | functional |
| | & Bonding | | groups |
| Organic | Organic | Nomenclature | Primary, |
| Chemistry | Structures | | secondary & |
| | & Bonding | | tertiary |
| Organic | Organic | Nomenclature | Naming of |
| Chemistry | Structures | | compounds |
| | & Bonding | | |
| Organic | Organic | Bonding & | Pi & sigma |
| Chemistry | Structures | structures | bonds |
| | & Bonding | | |
| Organic | Organic | Bonding & | Multiple bonds |
| Chemistry | Structures | structures | |
| | & Bonding | | |
| Organic | Organic | Bonding & | Configurations |
| Chemistry | Structures | structures | |
| | & Bonding | | |
| Organic | Organic | Bonding & | Conformations & |
| Chemistry | Structures | structures | strains |
| | & Bonding | | |
| Organic | Organic | Bonding & | Saturation & |
| Chemistry | Structures | structures | rings |
| | & Bonding | | |
| Organic | Organic | Bonding & | Resonance in |
| Chemistry | Structures | structures | organic |
| | & Bonding | | chemistry |
| Organic | Organic | Ring compounds | Cyclohexanes & |
| Chemistry | Structures | | torsional & |
| | & Bonding | | steric strain |
| Organic | Organic | Ring compounds | Other single |
| Chemistry | Structures | | rings & ring |
| | & Bonding | | strain |
| Organic | Organic | Ring compounds | Polycyclic |
| Chemistry | Structures | | rings |
| | & Bonding | | |
| Organic | Organic | Isomers | General |
| Chemistry | Structures | | overview of |
| | & Bonding | | isomers |
| Organic | Organic | Isomers | Cis-trans |
| Chemistry | Structures | | stereoisomers- |
| | & Bonding | | double bonds |
| Organic | Organic | Isomers | Cis-trans |
| Chemistry | Structures | | stereoisomers- |
| | & Bonding | | rings |
| Organic | Organic | Isomers | Optical |
| Chemistry | Structures | | isomers-general |
| | & Bonding | | overview |
| Organic | Organic | Isomers | Optical |
| Chemistry | Structures | | isomers- |
| | & Bonding | | absolute |
| | | | configuration |
| Organic | Oxygen | Alcohols | General |
| Chemistry | Containing | | overview |
| | Compounds | | |
| Organic | Oxygen | Alcohols | Alcohol |
| Chemistry | Containing | | physical |
| | Compounds | | properties |
| Organic | Oxygen | Alcohols | Alcohol acid |
| Chemistry | Containing | | base properties |
| | Compounds | | |
| Organic | Oxygen | Alcohols | Protection of |
| Chemistry | Containing | | alcoholic group |
| | Compounds | | |
| Organic | Oxygen | Alcohols | Reaction of |
| Chemistry | Containing | | tosylates & |
| | Compounds | | nucleophilic |
| | | | substitution |
| Organic | Oxygen | Alcohols | Alcohol |
| Chemistry | Containing | | reactions with |
| | Compounds | | PBr₃ & SOCl₂ |
| Organic | Oxygen | Alcohols | The Pinacol |
| Chemistry | Containing | | rearrangement |
| | Compounds | | |
| Organic | Oxygen | Carbonyl | Chemistry of |
| Chemistry | Containing | compounds | the carbonyl |
| | Compounds | | carbon |
| Organic | Oxygen | Carbonyl | Chemistry of |
| Chemistry | Containing | compounds | alpha carbons & |
| | Compounds | | keto-enol |
| Organic | Oxygen | Carbonyl | Chemistry of |
| Chemistry | Containing | compounds | alpha-beta |
| | Compounds | | unsaturated |
| | | | carbonyls |
| Organic | Oxygen | Carbonyl | Nomenclature of |
| Chemistry | Containing | compounds | carbonyl |
| | Compounds | | compounds |
| Organic | Oxygen | Carbonyl | Nucleophilic |
| Chemistry | Containing | compounds | additions to |
| | Compounds | | carbonyls |
| Organic | Oxygen | Carbonyl | Aldol |
| Chemistry | Containing | compounds | condensation |
| | Compounds | | |
| Organic | Oxygen | Carbonyl | Other reactions |
| Chemistry | Containing | compounds | of carbonyls |
| | Compounds | | |
| Organic | Oxygen | Carboxylic | Chemistry of |
| Chemistry | Containing | acids & | carboxylic acid |
| | Compounds | derivatives | derivatives |
| Organic | Oxygen | Carboxylic | Carboxylic acid |
| Chemistry | Containing | acids & | derivatives |
| | Compounds | derivatives | nomenclature |
| Organic | Oxygen | Carboxylic | Carboxylic acid |
| Chemistry | Containing | acids & | derivatives |
| | Compounds | derivatives | physical |
| | | | properties |
| Organic | Oxygen | Carboxylic | Ester formation |
| Chemistry | Containing | acids & | & hydrolysis |
| | Compounds | derivatives | |
| Organic | Oxygen | Carboxylic | Amide formation |
| Chemistry | Containing | acids & | & chemistry |
| | Compounds | derivatives | |
| Organic | Oxygen | Carboxylic | Decarboxylation |
| Chemistry | Containing | acids & | reactions |
| | Compounds | derivatives | |
| Organic | Oxygen | Carboxylic | Carboxyic acid |
| Chemistry | Containing | acids & | derivatives' |
| | Compounds | derivatives | chemistry & |
| | | | reactions |
| Organic | Oxygen | Nucleophilic | General |
| Chemistry | Containing | substitution | overview of |
| | Compounds | reactions | nucleophilic |
| | | | substitution |
| | | | reactions |
| Organic | Oxygen | Nucleophilic | S_{N}1 type of |
| Chemistry | Containing | substitution | nucleophilic |
| | Compounds | reactions | substitution |
| Organic | Oxygen | Nucleophilic | S_{N}2 type of |
| Chemistry | Containing | substitution | nucleophilic |
| | Compounds | reactions | substitution |
| Organic | Oxygen | Oxidation- | Oxidation- |
| Chemistry | Containing | reduction | reduction |
| | Compounds | reactions | reactions |
| | | organic | organic |
| Biology | Cell | Cell structure | Overview of |
| | Structure | & function | cells |
| | & Function | | |
| Biology | Cell | Cell structure | Cell structure |
| | Structure | & function | |
| | & Function | | |
| Biology | Cell | Cell structure | Cell organelles |
| | Structure | & function | |
| | & Function | | |
| Biology | Cell | Cell structure | Nucleus |
| | Structure | & function | structure |
| | & Function | | |
| Biology | Cell | Cell structure | Cytoskeleton |
| | Structure | & function | components |
| | & Function | | |
| Biology | Cell | Cell structure | Cytoskeleton |
| | Structure | & function | structures from |
| | & Function | | components |
| Biology | Cell | Cell structure | Intercellular |
| | Structure | & function | adhesions |
| | & Function | | |
| Biology | Cell | Membrane | General |
| | Structure | structure & | overview |
| | & Function | function | |
| Biology | Cell | Membrane | Chemical |
| | Structure | structure & | structure of |
| | & Function | function | membranes |
| Biology | Cell | Membrane | Membrane |
| | Structure | structure & | receptors |
| | & Function | function | |
| Biology | Cell | Membrane | Molecular types |
| | Structure | structure & | transported |
| | & Function | function | |
| Biology | Cell | Membrane | Simple |
| | Structure | structure & | diffusion |
| | & Function | function | |
| Biology | Cell | Membrane | Facilitated |
| | Structure | structure & | diffusion |
| | & Function | function | |
| Biology | Cell | Membrane | Active |
| | Structure | structure & | transport |
| | & Function | function | |
| Biology | Cell | Membrane | Osmosis |
| | Structure | structure & | |
| | & Function | function | |
| Biology | Cell | Membrane | Endocytosis & |
| | Structure | structure & | exocytosis |
| | & Function | function | |
| Biology | Cell | Cell division, | Cell cycle |
| | Structure | mitosis & | |
| | & Function | meiosis | |
| Biology | Cell | Cell division, | Mitosis |
| | Structure | mitosis & | overview |
| | & Function | meiosis | |
| Biology | Cell | Cell division, | Mitosis |
| | Structure | mitosis & | prophase |
| | & Function | meiosis | |
| Biology | Cell | Cell division, | Mitosis |
| | Structure | mitosis & | metaphase |
| | & Function | meiosis | |
| Biology | Cell | Cell division, | Mitosis |
| | Structure | mitosis & | anaphase |
| | & Function | meiosis | |
| Biology | Cell | Cell division, | Mitosis |
| | Structure | mitosis & | telophase |
| | & Function | meiosis | |
| Biology | Cell | Cell division, | Contrast |
| | Structure | mitosis & | mitosis & |
| | & Function | meiosis | meiosis |
| Biology | Cell | Cell division, | Spindle |
| | Structure | mitosis & | apparatus |
| | & Function | meiosis | |
| Biology | Cell | Energy | General |
| | Structure | metabolism | overview |
| | & Function | | |
| Biology | Cell | Energy | High energy |
| | Structure | metabolism | compounds |
| | & Function | | |
| Biology | Cell | Energy | Glycolysis |
| | Structure | metabolism | |
| | & Function | | |
| Biology | Cell | Energy | Fermentation |
| | Structure | metabolism | |
| | & Function | | |
| Biology | Cell | Energy | Kreb's cycle |
| | Structure | metabolism | |
| | & Function | | |
| Biology | Cell | Energy | Electron |
| | Structure | metabolism | transport |
| | & Function | | system |
| Biology | Cell | Energy | Oxidative |
| | Structure | metabolism | phosphorylation |
| | & Function | | |
| Biology | Cell | Energy | Energy |
| | Structure | metabolism | metabolism |
| | & Function | | summary |
| Biology | Cell | Enzymes | General |
| | Structure | | overview |
| | & Function | | |
| Biology | Cell | Enzymes | Examples of |
| | Structure | | enzymes |
| | & Function | | |
| Biology | Cell | Enzymes | Enzyme |
| | Structure | | structure |
| | & Function | | |
| Biology | Cell | Enzymes | Enzyme |
| | Structure | | specificity & |
| | & Function | | affinity |
| Biology | Cell | Enzymes | Enzyme |
| | Structure | | catalysis |
| | & Function | | |
| Biology | Cell | Enzymes | Enzyme |
| | Structure | | inhibitors |
| | & Function | | |
| Biology | Cell | Enzymes | Enzyme kinetics |
| | Structure | | |
| | & Function | | |
| Biology | Cell | Enzymes | Enzyme control |
| | Structure | | |
| | & Function | | |
| Biology | Cell | Enzymes | Factors |
| | Structure | | affecting |
| | & Function | | enzymes |
| Biology | Genetics & | Genetics | Chromosomes & |
| | Evolution | | alleles |
| Biology | Genetics & | Genetics | Mendel's Laws |
| | Evolution | | |
| Biology | Genetics & | Genetics | Sex linked |
| | Evolution | | traits |
| Biology | Genetics & | Genetics | Genetic |
| | Evolution | | calculations |
| Biology | Genetics & | Genetics | Genetic |
| | Evolution | | variability- |
| | | | General |
| Biology | Genetics & | Genetics | Genetic |
| | Evolution | | variability- |
| | | | recombination |
| | | | of alleles |
| Biology | Genetics & | Genetics | Genetic |
| | Evolution | | variability- |
| | | | example of |
| | | | recombination |
| Biology | Genetics & | Genetics | Genetic |
| | Evolution | | variability- |
| | | | Mutations |
| | | | General |
| Biology | Genetics & | Genetics | Genetic |
| | Evolution | | variability- |
| | | | Mutations Types |
| Biology | Genetics & | Genetics | Genetic |
| | Evolution | | variability- |
| | | | Results of |
| | | | mutations |
| Biology | Genetics & | Evolution | General |
| | Evolution | | overview |
| Biology | Genetics & | Evolution | Scientific |
| | Evolution | | support |
| Biology | Genetics & | Evolution | Early phases of |
| | Evolution | | evolution |
| Biology | Genetics & | Evolution | Taxonomy |
| | Evolution | | |
| Biology | Genetics & | Evolution | Evolution of |
| | Evolution | | invertebrates- |
| | | | general |
| Biology | Genetics & | Evolution | Evolution of |
| | Evolution | | invertebrates- |
| | | | major factors |
| Biology | Genetics & | Evolution | Evolution of |
| | Evolution | | invertebrates- |
| | | | general |
| | | | groupings |
| Biology | Genetics & | Evolution | Evolution of |
| | Evolution | | vertebrates- |
| | | | general |
| Biology | Genetics & | Evolution | Evolution of |
| | Evolution | | vertebrates- |
| | | | general groups |
| Biology | Genetics & | Evolution | Natural |
| | Evolution | | selection |
| Biology | Genetics & | Evolution | Species |
| | Evolution | | formation |
| Biology | Genetics & | Evolution | Hardy-Weinberg- |
| | Evolution | | general |
| Biology | Genetics & | Evolution | Hardy-Weinberg- |
| | Evolution | | required |
| | | | factors |
| Biology | Genetics & | Evolution | Hardy-Weinberg- |
| | Evolution | | binomial |
| | | | relation |
| Biology | Genetics & | Ecological | Ecological |
| | Evolution | relationships | relationships |
| Biology | Genetics & | Behaviors | Behaviors |
| | Evolution | | |
| Biology | Microbiology | Bacteria | Bacterial |
| | | | structure |
| Biology | Microbiology | Bacteria | Bacterial |
| | | | shapes |
| Biology | Microbiology | Bacteria | Bacterial |
| | | | metabolism |
| Biology | Microbiology | Bacteria | Bacterial |
| | | | reproduction |
| Biology | Microbiology | Bacteria | Bacterial |
| | | | growth |
| Biology | Microbiology | Bacteria | Disease |
| | | | causation |
| Biology | Microbiology | Viruses | General |
| | | | characteristics |
| Biology | Microbiology | Viruses | Bacteriophages |
| Biology | Microbiology | Viruses | Viral life |
| | | | cycle |
| Biology | Microbiology | Protozoa | Protozoa |
| Biology | Microbiology | Fungi | General |
| | | | overview |
| Biology | Microbiology | Fungi | Reproduction |
| Biology | Nucleic | Nucleic acids | Overall |
| | Acids | | relations |
| Biology | Nucleic | Nucleic acids | Nucleotide |
| | Acids | | structure |
| Biology | Nucleic | Nucleic acids | Polynucleotides |
| | Acids | | |
| Biology | Nucleic | Nucleic acids | DNA-general |
| | Acids | | overview |
| Biology | Nucleic | Nucleic acids | DNA-double |
| | Acids | | helix |
| Biology | Nucleic | Nucleic acids | Chromosomal |
| | Acids | | structure |
| Biology | Nucleic | Nucleic acids | DNA-Replication |
| | Acids | | |
| Biology | Nucleic | Nucleic acids | DNA |
| | Acids | | transcription |
| | | | to RNA-initial |
| | | | transcription |
| Biology | Nucleic | Nucleic acids | DNA |
| | Acids | | transcription |
| | | | to RNA-post |
| | | | transcription |
| | | | modifications |
| Biology | Nucleic | Nucleic acids | DNA |
| | Acids | | transcription |
| | | | to RNA-control |
| | | | of |
| | | | transcription |
| Biology | Nucleic | Nucleic acids | Cancer as |
| | Acids | | failure of |
| | | | control |
| | | | mechanisms |
| Biology | Nucleic | Nucleic acids | mRNA |
| | Acids | | |
| Biology | Nucleic | Nucleic acids | genetic code |
| | Acids | | |
| Biology | Nucleic | Nucleic acids | rRNA & |
| | Acids | | ribosomes |
| Biology | Nucleic | Nucleic acids | tRNA |
| | Acids | | |
| Biology | Nucleic | Nucleic acids | summary of |
| | Acids | | relations of |
| | | | gene codon & |
| | | | anticodon |
| Biology | Nucleic | Protein | Protein |
| | Acids | biosynthesis | biosynthesis |
| Biology | Organ | Blood | General |
| | Systems | | |
| Biology | Organ | Blood | Red cells & |
| | Systems | | hemoglobin |
| Biology | Organ | Blood | White cells |
| | Systems | | |
| Biology | Organ | Blood | Coagulation |
| | Systems | | |
| Biology | Organ | Blood | Other |
| | Systems | | components |
| Biology | Organ | Blood | Acid & base |
| | Systems | | balance in |
| | | | blood (pH) |
| Biology | Organ | Blood | Blood types |
| | Systems | | |
| Biology | Organ | Bones & joints | Cartilage & |
| | Systems | | joints |
| Biology | Organ | Bones & joints | General on |
| | Systems | | skeletal system |
| Biology | Organ | Bones & joints | Composition of |
| | Systems | | bone |
| Biology | Organ | Bones & joints | Long bone |
| | Systems | | structure |
| Biology | Organ | Bones & joints | Anatomy terms |
| | Systems | | |
| Biology | Organ | Cardiovascular | Heart structure |
| | Systems | | |
| Biology | Organ | Cardiovascular | Mechanical |
| | Systems | | heart function |
| Biology | Organ | Cardiovascular | Electrical |
| | Systems | | heart function |
| Biology | Organ | Cardiovascular | Vascular system |
| | Systems | | overview |
| Biology | Organ | Cardiovascular | Arteries |
| | Systems | | |
| Biology | Organ | Cardiovascular | Veins |
| | Systems | | |
| Biology | Organ | Cardiovascular | Capillaries |
| | Systems | | exchange |
| Biology | Organ | Cardiovascular | Lymphatic |
| | Systems | | system |
| Biology | Organ | Endocrine | General |
| | Systems | system | overview |
| Biology | Organ | Endocrine | Mechanism of |
| | Systems | system | action of |
| | | | hormones |
| Biology | Organ | Endocrine | Endocrine |
| | Systems | system | negative |
| | | | feedback |
| Biology | Organ | Endocrine | Hypothalamus |
| | Systems | system | hormones |
| Biology | Organ | Endocrine | Anterior |
| | Systems | system | pituitary |
| | | | hormones |
| Biology | Organ | Endocrine | Adrenal |
| | Systems | system | hormones |
| Biology | Organ | Endocrine | Thyroid |
| | Systems | system | hormones |
| Biology | Organ | Endocrine | Calcium |
| | Systems | system | metabolism |
| Biology | Organ | Endocrine | Pancreas |
| | Systems | system | hormones |
| Biology | Organ | Endocrine | Kidney hormones |
| | Systems | system | |
| Biology | Organ | Excretory | General |
| | Systems | system | overview |
| Biology | Organ | Excretory | Kidney & blood |
| | Systems | system | pressure |
| Biology | Organ | Excretory | Body fluids |
| | Systems | system | |
| Biology | Organ | Excretory | Kidney |
| | Systems | system | structure |
| | | | description |
| Biology | Organ | Excretory | Kidney |
| | Systems | system | structure |
| | | | diagram |
| Biology | Organ | Gastrointestinal | General |
| | Systems | system- | overview |
| | | general | |
| Biology | Organ | Gastrointestinal | Oral structures |
| | Systems | system- | |
| | | general | |
| Biology | Organ | Gastrointestinal | Stomach |
| | Systems | system- | |
| | | general | |
| Biology | Organ | Gastrointestinal | Small intestine |
| | Systems | system- | |
| | | general | |
| Biology | Organ | Gastrointestinal | Liver |
| | Systems | system- | |
| | | general | |
| Biology | Organ | Gastrointestinal | Gall bladder |
| | Systems | system- | |
| | | general | |
| Biology | Organ | Gastrointestinal | Pancreas |
| | Systems | system- | |
| | | general | |
| Biology | Organ | Gastrointestinal | Colon |
| | Systems | system- | |
| | | general | |
| Biology | Organ | Gastrointestinal | Digestion |
| | Systems | system- | |
| | | general | |
| Biology | Organ | Gastrointestinal | General |
| | Systems | system- | overview |
| | | nutrients | |
| Biology | Organ | Gastrointestinal | Nutrient |
| | Systems | system- | metabolism |
| | | nutrients | |
| Biology | Organ | Gastrointestinal | Nutrient |
| | Systems | system- | elimination |
| | | nutrients | |
| Biology | Organ | Gastrointestinal | Carbohydrates |
| | Systems | system- | |
| | | nutrients | |
| Biology | Organ | Gastrointestinal | Fats |
| | Systems | system- | |
| | | nutrients | |
| Biology | Organ | Gastrointestinal | Proteins |
| | Systems | system- | |
| | | nutrients | |
| Biology | Organ | Gastrointestinal | Vitamins |
| | Systems | system- | |
| | | nutrients | |
| Biology | Organ | Gastrointestinal | Minerals |
| | Systems | system- | |
| | | nutrients | |
| Biology | Organ | Homeostasis | General |
| | Systems | | overview |
| Biology | Organ | Homeostasis | Fluid |
| | Systems | | homeostasis |
| Biology | Organ | Homeostasis | Ion homeostasis |
| | Systems | | |
| Biology | Organ | Homeostasis | Oxygen |
| | Systems | | homeostasis |
| Biology | Organ | Homeostasis | Acid-base |
| | Systems | | homeostasis |
| Biology | Organ | Homeostasis | Blood pressure |
| | Systems | | homeostasis |
| Biology | Organ | Homeostasis | Blood Sugar |
| | Systems | | homeostasis |
| Biology | Organ | Homeostasis | Gastrointestinal |
| | Systems | | homeostasis |
| Biology | Organ | Homeostasis | Cardiovascular |
| | Systems | | homeostasis |
| Biology | Organ | Homeostasis | Respiratory |
| | Systems | | homeostasis |
| Biology | Organ | Homeostasis | Excretory |
| | Systems | | system |
| | | | homeostasis |
| Biology | Organ | Immune system | Non-specific |
| | Systems | | defenses |
| Biology | Organ | Immune system | General |
| | Systems | | overview of |
| | | | immune system |
| Biology | Organ | Immune system | Humoral |
| | Systems | | immunity |
| Biology | Organ | Immune system | Cellular |
| | Systems | | immunity |
| Biology | Organ | Immune system | Immune response |
| | Systems | | |
| Biology | Organ | Immune system | Vaccines |
| | Systems | | |
| Biology | Organ | Muscles | General |
| | Systems | | overview |
| Biology | Organ | Muscles | Muscle |
| | Systems | | structure |
| Biology | Organ | Muscles | Muscle |
| | Systems | | contraction |
| | | | mechanics |
| Biology | Organ | Muscles | Muscle |
| | Systems | | contractions- |
| | | | microscopic |
| Biology | Organ | Muscles | Muscle |
| | Systems | | contraction |
| | | | physiology |
| Biology | Organ | Muscles | Control of |
| | Systems | | muscle action |
| Biology | Organ | Muscles | Muscle |
| | Systems | | metabolism |
| Biology | Organ | Nervous system | General |
| | Systems | concepts | overview |
| Biology | Organ | Nervous system | Nerve cell |
| | Systems | concepts | types |
| Biology | Organ | Nervous system | Brain |
| | Systems | concepts | |
| Biology | Organ | Nervous system | Spinal cord |
| | Systems | concepts | |
| Biology | Organ | Nervous system | Peripheral |
| | Systems | concepts | nervous system |
| Biology | Organ | Nervous system | Autonomic |
| | Systems | concepts | nervous system |
| Biology | Organ | Nervous system | Neuron |
| | Systems | physiology- | structures |
| | | general | |
| Biology | Organ | Nervous system | Neuron types |
| | Systems | physiology- | |
| | | general | |
| Biology | Organ | Nervous system | Action |
| | Systems | physiology- | potentials- |
| | | general | discussion |
| Biology | Organ | Nervous system | Action |
| | Systems | physiology- | potentials- |
| | | general | depolarization |
| Biology | Organ | Nervous system | Action |
| | Systems | physiology- | potentials- |
| | | general | repolarization |
| Biology | Organ | Nervous system | Hearing anatomy |
| | Systems | physiology- | |
| | | hearing & | |
| | | balance | |
| Biology | Organ | Nervous system | Hearing |
| | Systems | physiology- | physiology |
| | | hearing & | |
| | | balance | |
| Biology | Organ | Nervous system | Balance & |
| | Systems | physiology- | equilibrium |
| | | hearing & | |
| | | balance | |
| Biology | Organ | Nervous system | General |
| | Systems | physiology- | overview |
| | | sensory | |
| | | systems, other | |
| Biology | Organ | Nervous system | Olfaction & |
| | Systems | physiology- | taste |
| | | sensory | |
| | | systems, other | |
| Biology | Organ | Nervous system | Somatic & |
| | Systems | physiology- | visceral |
| | | sensory | |
| | | systems, other | |
| Biology | Organ | Nervous system | Eye anatomy |
| | Systems | physiology- | |
| | | vision | |
| Biology | Organ | Nervous system | Image formation |
| | Systems | physiology- | by the eye |
| | | vision | |
| Biology | Organ | Nervous system | Retinal & brain |
| | Systems | physiology- | function of the |
| | | vision | eye |
| Biology | Organ | Nervous system | Characteristics |
| | Systems | physiology- | of |
| | | neurotransmitters | neurotransmitters |
| Biology | Organ | Nervous system | Types of |
| | Systems | physiology- | neurotransmitters |
| | | neurotransmitters | |
| Biology | Organ | Nervous system | synapses |
| | Systems | physiology- | |
| | | neurotransmitters | |
| Biology | Organ | Respiratory | General |
| | Systems | system | overview |
| Biology | Organ | Respiratory | Respiratory |
| | Systems | system | anatomy & |
| | | | function |
| Biology | Organ | Respiratory | Rate of |
| | Systems | system | breathing |
| Biology | Organ | Respiratory | Mechanics of |
| | Systems | system | breathing |
| Biology | Organ | Respiratory | Gas exchange & |
| | Systems | system | transport |
| Biology | Organ | Respiratory | Control of |
| | Systems | system | breathing |
| Biology | Organ | Skin | Skin |
| | Systems | | |
| Biology | Organ | Temperature | General |
| | Systems | regulation | overview |
| Biology | Organ | Temperature | Mechanisms of |
| | Systems | regulation | heat transfer |
| | | | in organisms |
| Biology | Organ | Temperature | Mechanisms of |
| | Systems | regulation | heat |
| | | | conservation in |
| | | | organisms |
| Biology | Organ | Temperature | Mechanisms of |
| | Systems | regulation | heat loss in |
| | | | organisms |
| Biology | Organ | Tissues | General |
| | Systems | | overview |
| Biology | Organ | Tissues | Epithelial |
| | Systems | | cells |
| Biology | Organ | Tissues | Connective |
| | Systems | | tissue |
| Biology | Reproductive | Embryology | Embryology |
| | Biology | | mechanisms- |
| | | | determination |
| Biology | Reproductive | Embryology | Embryology |
| | Biology | | mechanisms- |
| | | | differentiation |
| Biology | Reproductive | Embryology | Embryology |
| | Biology | | mechanisms- |
| | | | other |
| Biology | Reproductive | Embryology | Embryologic |
| | Biology | | sequence to |
| | | | gastrula |
| Biology | Reproductive | Embryology | Embryologic |
| | Biology | | sequence to |
| | | | neural tube |
| Biology | Reproductive | Embryology | Embryology |
| | Biology | | layer outcomes |
| Biology | Reproductive | Reproductive | General |
| | Biology | Biology-gametes | overview |
| Biology | Reproductive | Reproductive | Gamete |
| | Biology | Biology-gametes | formation in |
| | | | males |
| Biology | Reproductive | Reproductive | Gamete |
| | Biology | Biology-gametes | formation in |
| | | | females |
| Biology | Reproductive | Reproductive | Fertilization |
| | Biology | Biology-gametes | |
| Biology | Reproductive | Reproductive | Primary sex |
| | Biology | Biology-Females | characteristics |
| Biology | Reproductive | Reproductive | Secondary sex |
| | Biology | Biology-Females | characteristics |
| Biology | Reproductive | Reproductive | Female sexual |
| | Biology | Biology-Females | response |
| Biology | Reproductive | Reproductive | Female life |
| | Biology | Biology-Females | cycle |
| Biology | Reproductive | Reproductive | Menstrual cycle |
| | Biology | Biology-Females | description |
| Biology | Reproductive | Reproductive | Primary sex |
| | Biology | Biology-males | characteristics |
| Biology | Reproductive | Reproductive | Secondary sex |
| | Biology | Biology-males | characteristics |
| Biology | Reproductive | Reproductive | Male sexual |
| | Biology | Biology-males | response |

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A system for preparing a user for a standardized test comprising:
means for providing assessment tools;
means for providing study materials; and
means for providing support tools.

2. The system of claim 1 wherein the assessment tools include at least one diagnostic test.

3. The system of claim 2 wherein said means for providing assessment tools further comprises a question pool containing a plurality of questions, and said diagnostic test comprises a plurality of questions drawn from said question pool.

4. The system of claim 1 wherein said assessment tools include previously administered standardized tests provided by a testing entity.

5. The system of claim 1 wherein the user may access at least one of the assessment tools online.

6. The system of claim 2 further comprising means for analyzing and storing the results of the diagnostic test.

7. The system of claim 6 further comprising means for viewing the results of at least one diagnostic test.

8. The system of claim 1 wherein said study material include at least one presentation on at least one specific content area covered by the standardized test.

9. The system of claim 1 wherein said study materials includes at least one presentation on test taking skills.

10. The system of claim 1 wherein the study materials include an explanation of answers to at least one previously administered standardized test question.

11. The system of claim 1 wherein the study materials include a glossary.

12. The system of claim 1 wherein the study materials include at least one flashcard.

13. The system of claim 1 wherein said study materials include at least one equation.

14. The system of claim 1 wherein the study materials include a flag tool.

15. The system of claim 1 wherein the study materials include a comment tool.

16. The system of claim 1 wherein the study materials include at least one audio recording.

17. The system of claim 1 wherein the study materials include at least one video recording.

18. The system of claim 1 wherein the study materials include at least one ancillary reading material.

19. The system of claim 1 wherein the user may access at least one of the study materials online.

20. The system of claim 6 further comprising means for processing and storing an analysis of at least one previously administered standardized test.

21. The system of claim 20 further comprising means for generating a study plan based on the results of at least one diagnostic test and the analysis of at least one previously administered standardized test.

22. The system of claim 20 further comprising means for entering user information into the system.

23. The system of claim 22 wherein said user information includes the user's goal score on the standardized test.

24. The system of claim 23 further comprising means for generating a study plan based on the results of at least one diagnostic test, the analysis of at least one previously administered standardized test, and the user's goal score.

25. The system of claim 1 wherein the system further includes means for sending at least a portion of the study materials to a portable receiving device.

26. The system of claim 1 wherein the user may access at least one of the support materials online.

27. A computerized learning method for improving a user's performance on a standardized test, said method comprising the steps of:
a. administering a diagnostic test to the user;
b. analyzing the results of the diagnostic test;
c. generating a study plan;
d. providing study materials to the user;
e. repeating steps a-d until the user is prepared to take the standardized test.

28. The method of claim 27 further comprising providing user support resources.

29. The method of claim 28 wherein said study plan is generated based on at least the results of the diagnostic test.

30. The method of claim 27 further comprising the step of accepting user data.

31. The method of claim 30 wherein said user data further comprises a goal standardized test score.

32. The method of claim 31 wherein said study plan is generated based on at least the user goal standardized test score.

33. The method of claim 27 further comprising analyzing at least one previously administered standardized test.

34. The method of claim 33 wherein said study plan is based on at least the results of analysis of the previously administered standardized test.

35. A method of providing for standardized test preparation comprising:
compiling a question pool;
compiling at least one study materials;
preparing an analysis of at least one previously administered standardized test;
storing said question pool, said at least one study materials, and said analysis of at least one previously administered standardized test electronically;
generating at least one diagnostic test, said diagnostic test being generated from said question pool based on the analysis of said at least one previously administered standardized test;
administering said at least one diagnostic test to a user;
storing the results of said at least one diagnostic test electronically; and
providing access to said study materials to at least one user.

36. The method of claim 35 further comprising
storing user profile data.

37. The method of claim 36 wherein said user profile data further comprises a goal standardized test score.

38. The method of claim 37 further comprising
generating a study plan, wherein said study plan is based on the results of said at least one diagnostic test, the analysis of said at least one previously administered standardized test and the user goal standardized test score.

39. The method of claim 38 wherein said study plan displays the order in which the user should review the at least one study material.

40. The method of claim 35 further comprising
providing user support resources, said user support resources being provided electronically.

41. The method of claim 40 wherein said user support resources further comprise:
receiving at least one user question;
providing an answer to said question;
storing said answer to said user question electronically; and
providing access to said answer to said user question to said at least one user.
